(19) United States
(12) Patent Application Publication
(10) Pub. No.: US 2011/0291803 A1
(43) Pub. Date: Dec. 1, 2011

(54) RFID SECURITY AND MOBILITY ARCHITECTURE

(76) Inventors: Zeljko BAJIC, San Jose, CA (US); Nikola CARGONJA, San Carlos, CA (US); Joseph S.M. HO, Sunnyvale, CA (US); Richard SCHNELL, San Jose, CA (US)

(21) Appl. No.: 13/021,602

(22) Filed: Feb. 4, 2011

Related U.S. Application Data
(60) Provisional application No. 61/348,986, filed on May 27, 2010.
(60) Provisional application No. 61/366,200, filed on Jul. 21, 2010.
(60) Provisional application No. 61/380,986, filed on Sep. 8, 2010.

(51) Int. Cl. H04Q 5/22

(52) U.S. Cl. 340/10.1

(57) ABSTRACT

A method of communication between RFID devices that includes mutually authenticating the RFID devices is disclosed. Once mutual authentication is completed, one or more encrypted messages based on the encryption scheme can be exchanged between the RFID devices.

### RELATED APPLICATIONS

The present application claims priority to U.S. Provisional Application No. 61/348,986, filed on May 27, 2010, U.S. Provisional Application No. 61/366,200, filed on Jul. 21, 2010, and U.S. Provisional Application No. 61/380,986, filed on Sep. 8, 2010, each of which is herein incorporated by reference in its entirety.

### BACKGROUND

1. Field of the Invention

Embodiments of the present invention are directed towards secured communications in RFID environments.

2. Description of Related Art

Low-power wireless devices such as, for example, radio frequency (RF) tags have been in use for some time. Radio-frequency identification (RFID) systems typically include interrogators or readers that communicate with tags. Tags are typically attached to an article such as a shipping container or a package that is being shipped. The interrogator, then, can inventory the articles that are within its range.

Generally, an RFID tag system will include a number of tags that are attached to an asset such as a piece of inventory or a shipping asset. RFID tags include a transceiver to transmit and receive signals as well as a processor to process incoming signals from an interrogator and provide responses to the interrogator. As such, an interrogator can poll the tags that are within its range. The interrogator, then, can monitor tags as they arrive or leave an area of interest. The reader, then, periodically polls the tags within its range. Alternatively, tags can be monitored as they transit a particular area. The bandwidth of the interrogator and its range limits the number of tags that can be monitored by any given reader.

However, communications within the RFID system (e.g., between interrogator and tags) have typically been made in unsecured fashion. Secured data that may be held within a tag in an RFID system is often transmitted in the clear. Further, tags are vulnerable to unauthorized reading.

Therefore, there is a need for RFID systems that are capable of secured communications.

### SUMMARY

In some embodiments, a method of communication between RFID devices includes mutually authenticating the RFID devices; and exchanging one or more encrypted payloads based on the encryption scheme.

In some embodiments, a security environment includes a central server; and one or more security domains in communication with the central server, wherein the one or more security domains includes one or more readers that mutually authenticate tags and exchange encrypted messages with tags. A method of providing tag security according to some embodiments can include providing a tag security to a distribution center; writing the tag security into a tag at the distribution center; authenticating the tag at one or more shipping terminals on a shipping route; and decommissioning the tag at a decommissioning center.

These and other embodiments are further discussed below with respect to the following figures.

### BRIEF DESCRIPTION OF THE FIGURES

FIG. 1A illustrates a typical RFID environment according to some embodiments of the present invention.

FIG. 1B illustrates a dialog according to some embodiments of the present invention.

FIG. 2 illustrates a tag—initiated mutual authentication dialog according to some embodiments of the present invention.

FIG. 3 illustrates a reader-initiated mutual authentication dialog according to some embodiments of the present invention.

FIG. 4 illustrates another example dialog of a mutual authentication process.

FIG. 5 illustrates an example mutual authentication timing with multiple tags.

FIG. 6 illustrates an example dialog for mutual authentication utilizing certificates in the public key infrastructure (PKI) according to some embodiments of the present invention.

FIG. 7 illustrates an example dialog of a for mutual authentication utilizing PKI according to some embodiments of the present invention.

FIG. 8 illustrates an example of a dialog for mutual authentication utilizing PKI according to some embodiments of the present invention.

FIG. 9 illustrates an example of a dialog for mutual authentication utilizing PKI according to some embodiments of the present invention.

FIG. 10 illustrates an example of a dialog for mutual authentication utilizing PKI according to some embodiments of the present invention.

FIG. 11 illustrates an example of a dialog between a reader and multiple tags utilizing certificates as in FIG. 6.

FIG. 12 illustrates an example of a dialog between a reader and multiple tags utilizing PKI as shown in FIG. 8.

FIG. 13 illustrates a use case for secured RFID tag environments according to some embodiments of the present invention.

FIG. 14 illustrates mobility across RF security domains.

FIG. 15 illustrates mobility across RF security domains using certificates.

In the figures, elements having the same designation have the same or similar function.

### DETAILED DESCRIPTION

The figures and the following description relate to some embodiments by way of illustration only. It should be noted that from the following discussion, alternative embodiments of the structures and methods disclosed herein will be readily recognized as viable alternatives that may be employed without departing from the principles of the embodiments described herein.

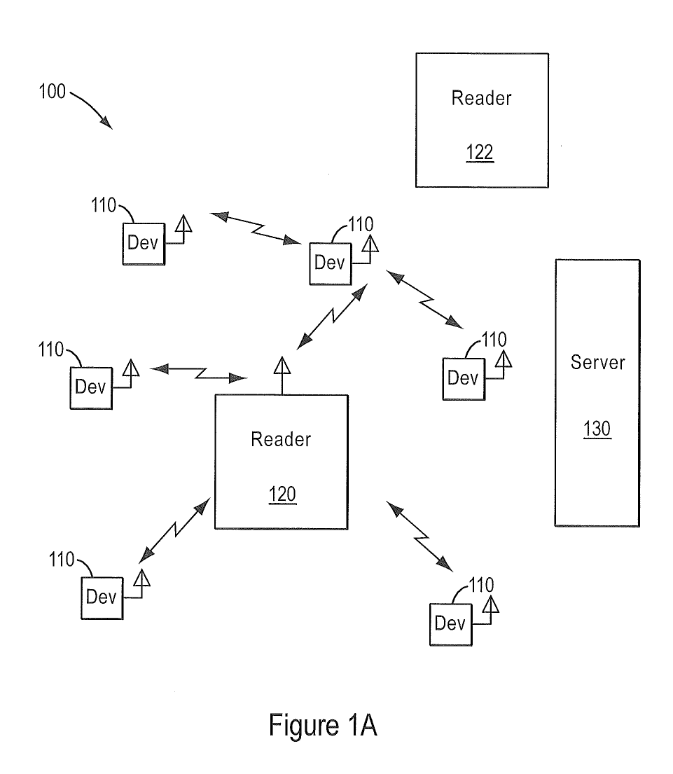

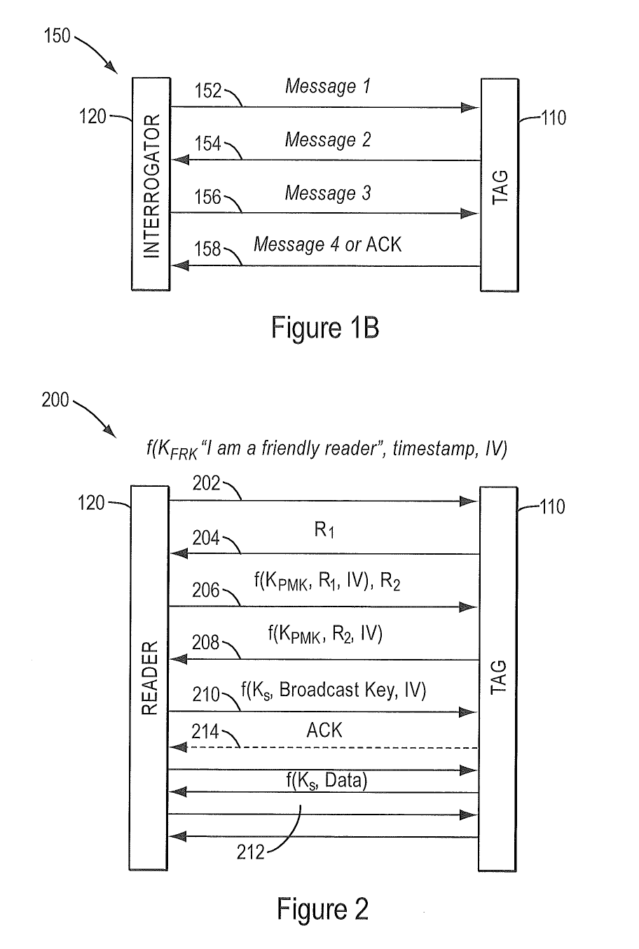

FIG. 1A illustrates a typical radio-frequency identification (RFID) domain 100. Devices 110 are typically attached to assets that are moved into and out of an area. Reader 120 and devices 110 communicate data. In some embodiments, reader 120 can be one of many mobile or fixed interrogators. Further, in some embodiments reader 120 may be part of an integrated RFID domain and may be controlled by a central server 130 in domain 100. Server 130 may communicate with multiple other readers 122 at domain 100. Domain 100 is an example of a security domain that may exists at a terminal or shipping point.

Readers 120 and 122 may include mobile, handheld, readers, signpost readers, or fixed readers. Throughout this description, the term reader is utilized interchangeably to mean reader or interrogator.

As shown in FIG. 1A, any number of devices 110 can be located in an area, where one of devices 110 is a reader 120. Reader 120 is one of devices 110 that performs the function of a reader or interrogator. Reader 120 communicates with one or more of devices 110 wirelessly in order to read or write information from the one or more devices 110. In some embodiments, reader 120 communications with the one or more devices 110, and devices 110 communicate with one another, forming a multi-channel system. As such, star and mesh networks of communicating devices 110 can be formed. Communications between devices 110 and reader 120 are further described in U.S. application Ser. No. 12/893,790, filed on Sep. 29, 2010, which is herein incorporated by reference in its entirety. As such, a packet mode of communications can be utilized.

Furthermore, various modulations can be utilized, for example Frequency Shift Keying (FSK) or Gaussian Filtered Frequency Shift Keying (GFSK). In general, any suitable modulation method can be utilized. Filtering can be utilized in order to limit the energy of each channel to its band and to provide a good power-spectral-density (PSD). Embodiments utilizing GFSK are capable of both limiting the out-of-band power and providing good PSD in the band.

In accordance with some embodiments of the present invention, both reader 120 and device 110 can implement a software security architecture that enables cryptographically secure communications. As discussed above, devices 110 are typically low-cost, low-power consumption, two-way, wireless nodes. In general, with the cryptographically secure communications in place, the security issues involved in wireless networks that include a large number of battery operated, wireless nodes can be mitigated.

The security protocols implemented within devices 110 and reader 120 can be implemented, for example, within a current standard such as the ISO 18000-7 Mode 1 and Mode 2 protocols as described in the Mode 2 application. Mode 1 is often referred to as the Base Mode while Mode 2 is an Extended Mode. Protocols utilizing secured communications according to aspects of the present invention can provide secure products for embedded wireless applications. Embodiments of the present invention can provide for the mutual authentication of embedded, low-power consumption wireless devices, encryption and authentication of the frames exchanged by the nodes, and support the mobility of wireless nodes between different RF security domains.

RFID standards, including the ISO/IEC 18000 series of standards, on RFID for item management do not typically consider any strong cryptographic security. The tag's unique item identifier (UII) is transmitted to every interrogator (i.e. reader) that is compliant to the standard, enabling unauthorized use and tracking of the tag. Sensitive information such as passwords and data written to the tag's memory, or other data that may be intended for private use, are sent from the reader to the tag in plain form. As well, access to any sensitive information on the tag has minimal restriction, and utilized passwords can be compromised easily. Some embodiments of the invention as described below can provide security methods for the effective protection of the tag and its sensitive data.

In accordance with some embodiments of the present invention, secured transmission of messages is established between tags 110 and reader 120 or between reader 120 and other readers such as reader 122. Implementing security protocols in a wireless environment such as that shown in FIG. 1A presents multiple challenges. In particular, as discussed above, there is a lack of standards defining security architectures that affects the mobility of tags 110 from one environment such as environment 100 to another environment (e.g., when an article with one of tags 110 is transported from one location to another). Additionally, in some embodiments different network topologies (e.g., star topologies, tree topologies, or mesh topologies) should be supported. Further, device 110 is limited by microprocessor performance, available memory, power consumption, and price. Further, device 110 typically does not support an internet protocol. Communications protocols in an environment such as environment 100 typically have short frame lengths (sometimes about 100 bytes). Additionally, there is often a large number devices 110 that are located within a particular geographic location. Further, devices 110 are often off-line in a power saving mode. Also, the physical security of devices 110 is hard to guarantee. Additionally, the contents stored in tags 110 should be protected.

The following symbols and abbreviations are utilized below:

### AES—Advanced Encryption Standard;

AES-CBC—AES with Cipher Block Chaining;

### HMAC—Hash-based Message Authentication Code;

### PKI—Public Key Infrastructure;

### PMK—Pairwise Master Key;

### PSK—Preshared Key;

### SHA-1—Secure Hash Algorithm 1.

The Advanced Encryption Standard is a symmetric-key encryption standard adopted by the U.S. government. AES was announced by the National Institute of Standards and Technology (NIST) as U.S. FIPS PUB 197 (FIPS 197), a publication that can be found at http://csrc.nist.gov/publications/fips/fips197/fips-197.pdf.

Security protocols according to some embodiments of the present invention include two components—the wireless RFID security infrastructure and the wired security infrastructure. The wired security infrastructure provides for a secure key distribution and support for the mobility of tags 110 between different RF security domains (which is discussed further below). As described herein, wireless RFID security infrastructure can be extensions of an existing protocol such as the ISO 18000-7 (Mode 1) protocols or the Mode 2 protocols. As such, in some embodiments at least some of devices 110 can support both wireless protocols and wired protocol, including internet protocol support.

In some embodiments, the wireless protocols can provide confidentiality by encrypting frames to protect message integrity; protect data integrity; provide replay protection with replay counters as part of the wireless frame; and protect against denial of service. Further, in some embodiments, mutual authentication of communicating devices 110 can occur. Secure key distribution can also be implemented. Additionally, in some embodiments mobility of tags 110 between different RF security domains is supported. In some embodiments, the security architecture according to some embodiments of the present invention can be aligned with FIPS 140-2 requirements, which defines a particular level of security.

The level of security provided by the security architecture depends on the safekeeping of the encryption keys, on the protection mechanisms employed, and on the proper implementation of the cryptographic mechanisms and associated security policies involved. Implementations of security protocols, such as key establishment, are often assumed to be properly and completely executed. Random number generators (RNG) are often assumed to operate as expected. The selection of the RNG algorithm is therefore assumed to be FIPS 140-2 compliant. Furthermore, it is often assumed that secret keys do not become available outside device 110 in an unsecured way. Lacking in these areas may result in a less secure environment.

FIG. 1B illustrates a dialog 150 between a reader (or interrogator) 120 and a tag 110 according to some embodiments of the present invention. As shown in FIG. 1B, dialog 150 can include a first message 152, a second message 154, and a third message 156. Upon completion of these messages, tag 110 and tag 120 have mutually authenticated each other. Message 158 can be a fourth message or an acknowledgment from tag 110.

FIG. 1B illustrates mutual authentication part of the framework dialog 150. The mutual authentication can be considered as a three way handshake, messages 152, 154, and 156, plus ACK message 158 or as a four way handshake or simple as a mutual authentication process handshake. The dialog 150 can define preshared key and certificate (PKI) based mutual authentication, but the framework dialog 150 can support any additional method for mutual authentication.

The first message 152 and the second message 154 can be Secure Challenge point-to-point commands that initiate mutual authentication between interrogator 120 and tag 110. First message 152 can take the form

| | | | |
|---|---|---|---|
| Command | Authentication | Key ID | Additional |
| code | Type | | fields specific |
| | | | for this new |
| | | | Authentication |
| | | | method |

where the command code indicates mutual authentication, Authentication Type indicates one of the mutual authentication types supported by the framework, and the key ID is an optional field where reader 120 can propose the Key ID for mutual authentication.

Second message, which is sent from tag 110 to interrogator 120, can take the form

| | | | |
|---|---|---|---|
| Command | Authentication | Key ID | Additional |
| code | Type | | fields specific |
| | | | for this new |
| | | | Authentication |
| | | | method |

where the Authentication Type is a mutual authentication type supported by the framework, and tag 110 can optionally propose a different Key specifying its index in the key table from that proposed by interrogater 120.

Third message 156 represents a Secure Challenge End point-to-point command that is used to complete the mutual authentication process. Message 156 is sent immediately after completion of a successful Secure Challenge Start command represented by message 154 and includes the distribution of the Encrypted Broadcast Message Key. Message 156 can take the form

| | | | | |
|---|---|---|---|---|
| Command | Authentication | Key ID | Additional fields | Encrypted |
| code | Type | | specific for this | Broadcast Msg |
| | | | new | Key |
| | | | Authentication | |
| | | | method | |

where the Authentication Type is a mutual authentication type supported by the framework, the Key ID is an optional field of the framework, and the Encrypted Broadcast Msg Key is a key used by tags to encrypt and decrypt broadcast messages the broadcast key is encrypted using the session key K_{S}.

Tag 110 response with the fourth message 158, which may be an acknowledgment. Tag 110 responds to the Secure Challenge End command with a point-to-point response shown as message 158. Message 158 can take the form

| | | | |
|---|---|---|---|
| Command | Authentication | Key ID | Additional |
| code | Type | | fields specific |
| | | | for this new |
| | | | Authentication |
| | | | method |

Mutual authentication between devices 110 and reader 120 (which may, in some embodiments, be identical to one of devices 110) can be based on a shared secret, may be based on public keys, certificates, or may be user defined. FIG. 2 illustrates an example of a mutual authentication dialog 200 based on shared secrets. FIG. 2 illustrates a mutual authentication dialog 200 that is initiated by tag 110, and not reader 120. As shown in FIG. 2, reader 120 first sends message 202 to tag 110. Message 202 includes an identifying string that identifies reader 120 as a friendly reader, a time stamp, and an initialization vector (IV) encrypted with encryption key K_{FRK}, f(K_{FRK}, “I am a friendly reader,” timestamp, IV). The string (identified as “I am a friendly reader” in FIG. 2) is any string that will identify reader 120 as a friendly reader to tag 110. The encryption key K_{FRK} used for encrypting this message is configured during a commission process of both tag 110 and reader 120. The commissioning process is further discussed below.

All tags 110 and friendly readers 120 can be commissioned with the encryption key K_{FRK}. In some embodiments, the friendly reader key K_{FRK} is not a factory set key, but is a user configurable key. The string “I am a friendly reader” is also configurable during the commissioning process to both friendly readers and tags. Message 202 can always be encrypted using a different IV (initialization vector) along with a timestamp, which prevents from replaying of the message. Besides configuring the parameters of the “I am a friendly reader” message during the commissioning process along with the friendly reader key K_{FRK}, the message can be configured using a secure link over the air. Although using the “I am a friendly reader” message 202 allows a reader 120 can identify itself as a friendly; this mechanism still cannot guarantee that environment 100 is friendly. In some embodiments, step 202 is optional and can be sent before performing another mutual authentication process.

Once received in tag 110, message 202 can be decrypted utilizing the friendly reader key K_{FRK} and the initialization vector IV to retrieve the message “I am a friendly reader.” If the received message matches that stored in tag 110, then tag 110 can recognize reader 120 as a friendly reader.

As shown in FIG. 2, tag 110 then sends a challenge R₁ in message 204. Challenge R₁ is an arbitrary string generated by tag 110, in some embodiments utilizing a random number generator. In dialog 200, challenge R₁ is sent in the clear to receiver 120. In some embodiments, the challenge R₁ sent in message 204 is a high quality random number that is 16 bytes in length.

In response to message 204, reader sends message 206. Message 206 includes challenge R1 encrypted by Pair-wise Master Key (PMK) K_{PMK} and an initialization vector IV, f(K_{PMK}, R1, IV) along with its own challenge R₂, challenge R₂ is sent in clear. The PMK key K_{PMK} is derived from a shared secret. The shared secret can be written into both reader 120 and tag 110 during their commissioning process.

The encryption (f(K, message, IV) can be performed by the Advanced Encryption Standard (AES) symmetric-key encryption as published by the National Institute of Standards and Technology (NIST) as U.S. FIPS Pub. 197 (FIPS 197), a copy of which can be found at http://csrc.nist.gov/publications/fips/fips197/fips-197.pdf, which is herein incorporated by reference in its entirety. Further, the AES encryption scheme can be performed in Cipher-Block Chaining (CBC) mode utilizing an initialization vector (IV) that is not repeated with the same key. In CBC mode, the first message is encoded utilizing the initialization vector and the encryption key and subsequent messages are encoded utilizing the encrypted previous message and the encryption key.

Once tag 110 receives message 206, then tag 110 can decrypt the message f(K_{PMK}, R1, IV) to retrieve the challenge R₁. If the decrypted challenge R₁ matches the challenge R₁ that was sent in message 204, then reader 120 is authenticated to tag 110, i.e. reader 120 has shown that it knows the shared secret that results in PMK K_{PMK}.

Tag 110 then encrypts the challenge R₂ sent by reader 120 and sends message 208, which is the encrypted message f(K_{PMK}, R2, IV). When message 208 is received at reader 120, it is decrypted to recover challenge R₂. If challenge R₂ matches the challenge R₂ that was sent in message 206, then tag 110 has been authenticated to reader 120.

Once tag 110 and reader 120 have each been authenticated to each other, by each proving to the other that they know the shared secret, then they can exchange encrypted and authenticated data frames. If reader 120 and tag 110 do not know the pre-shared secret, they will not be mutually authenticated and will not be able to exchange encrypted message. In some embodiments, they may retry a number of times to perform the mutual authentication. If mutual authentication fails, then tag 110 and reader 120 may refuse to communicate.

As shown in FIG. 2, once message 208 has been received by reader 120 and reader 120 and tag 110 have been mutually authenticated, then reader 120 transmits message 210, f(K_{S}, Broadcast Key, IV). Message 210 includes the broadcast key, encrypted with the unicast session key K_{S} and an initialization vector IV. The broadcast key can be utilized to encrypt and decrypt messages sent in broadcast (reader to multiple tags) mode. As shown in FIG. 2, in response to transmission of message 210 tag 110 can acknowledge receipt of the broadcast key with an acknowledgment ACK 214.

As further shown, frames can then be exchanged in messages 212 utilizing the session key K_{S} to encrypt each frame, as such messages 212 take the form f(K_{S}, frame). The session key K_{S} can be utilized to exchange encrypted messages between reader 120 and that particular tag 110 (point-to-point mode). The pre-shared secret can be utilized for derivation of the session keys, which are utilized throughout the interaction of tag 110 with reader 120. The frame can, as shown in FIG. 2, include data that is transmitted in an encrypted fashion between tag 110 and reader 120.

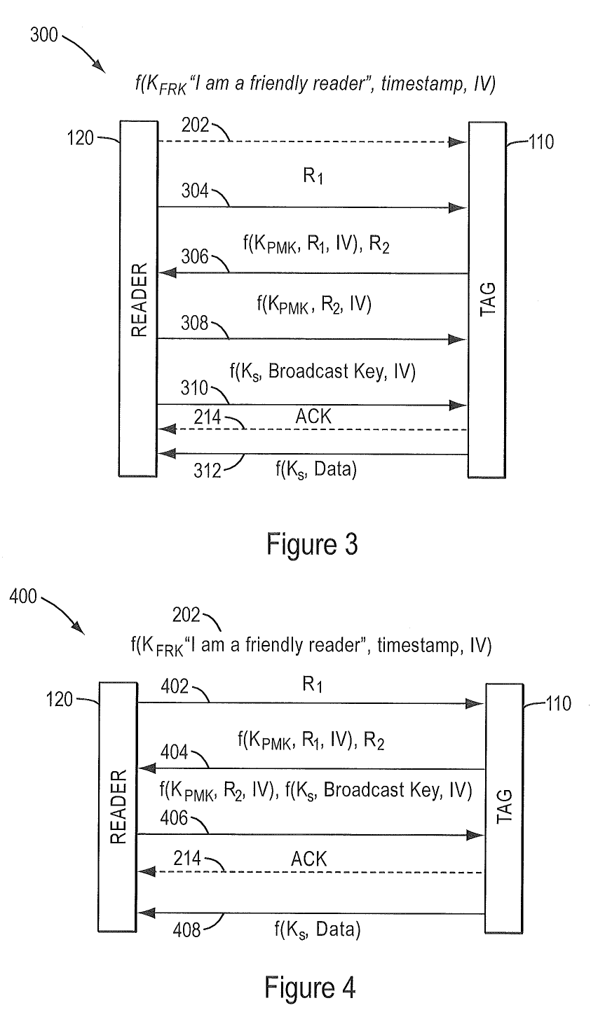

FIG. 3 illustrates a dialog 300 where reader 120 initiates the mutual authentication. As shown in FIG. 3, once again reader 120 may send message 202 as discussed above. However, in some embodiments message 202 is optional. As before, however, both reader 120 and tag 110 can authenticated if the show to the other that they know the same pre-shared secret. Again, once the authentication process is completed, then they can exchange encrypted messages.

As shown in FIG. 3, reader 120 sends message 304 to tag 110. Message 304 is challenge R₁ in clear. When received in tag 110, tag 110 sends message 306. Message 306 is f(K_{PMK}, R1, IV), R2. That is, message 306 is challenge R₁ encrypted with pair-wise master key K_{PMK} and initialization vector IV, and challenge R₂ in clear. Once message 306 is received in reader 120, then reader 120 can verify that tag 110 knows the shared secret. Reader 120 then sends message 308, which is the encrypted challenge R2, f(K_{PMK}, R2, IV). When message 308 is received by tag 110, then tag 110 verifies that reader 120 knows the shared secret. Meanwhile, reader 120 can transmit the broadcast key in message 310, f(K_{S}, Broadcast Key, IV). The broadcast key is utilized to encrypt or decrypt broadcast messages. As shown in FIG. 3, in some embodiments tag 110 can acknowledge receipt of the broadcast key with ACK 214. Message 312 in FIG. 3 depicts the transmission of encrypted frames f(K_{S}, Data) between reader 120 and tag 110 that can occur once the mutual authentication process is complete.

As discussed previously, challenges R₁ and R₂ can, in some embodiments, be 16 bytes in length. The Pair-wise Master Key K_{PMK} is derived from the shared secret. The Master Key KPMK can have any length, for example 128, 192, and 256 bit keys can be utilized. The session key K_{S} can then be derived from challenges R₁ and R₂ and the shared secret. Further, the encryption algorithm can be symmetric algorithms, for example the AES algorithm in CBC mode.

FIG. 4 illustrates another example dialog 400 that can be utilized to authenticate reader 120 with tag 110. As shown in FIG. 4, dialog 400 starts with optional transmission of message 202 from reader 120. The example shown in FIG. 4 is a reader initiated authentication, therefore reader 120 sends challenge R₁ in message 402. As before, tag 110 responds by transmitting message 404, which is encrypted challenge R₁ and challenge R₂ (f(K_{PMK}, R₁, IV), R₂). Once reader 120 receives message 404, and verifies that tag 110 knows the shared secret, then receiver can send message 406, which includes both the encrypted challenge R₂ and the encrypted broadcast key (f(K_{PMK}, R₂, IV), f(K₂, Broadcast Key, IV)). Once message 406 is received by tag 110, then tag 110 can verify that reader 120 knows the shared secret. In some embodiments, tag 110 can acknowledge receipt of the broadcast key in message 406 with ack 214. Encrypted data, f(K_{S}, Data), can then be sent in between tag 110 and reader 120 as shown in message 408. Dialog 400 is an example of a three-way handshake for mutual authentication.

Messages are transmitted between reader 120 and tag 110 in packet format. As discussed above, packets may be compatible a standard such as Mode 1 ISO 18000-7. In general, however, packets utilized for communications between reader 120 and tag 110 can take any format. As such, packets as described herein should be considered examples only and are not limiting.

Message 204 in FIG. 2, message 304 in FIG. 3, and message 402 in FIG. 4 are transmission of a challenge R₁ between reader 120 and tag 110. An example of challenge tag command format can be, for example, the frame given by:

| | Authentication | | |
|---|---|---|---|
| Command code | Type | Key ID | Challenge R₁ |
| TBD | 1 byte | 2 bytes | 16 bytes |

where the command code indicates an authentication process; authentication type indicates that the authentication process is based on a shared secret; the key ID indicates which of a number of keys K_{PMK} to utilize, for example by operating as a key index to a key table; and the challenge R₁ is a high quality random number, in this case of 16 byte length. The Key ID field can be utilized to propose a key for the pre-shared key K_{PMK} to be used for mutual authentication. If the receiver (tag 110 or reader 120) has the PMK with the same key ID, the receiver will use the PMK for mutual authentication. If the receiver does not have the proposed PMK, then the receiver will use one which it has and put that key ID in the second message.

The second message, messages 206, 306, and 404, can be transmitted in a frame packet, for example given by

| | | | Encrypted | | |
|---|---|---|---|---|---|
| Command | Authentication | | challenge | | |
| code | Type | Key ID | R₁ | IV | Challenge R₂ |
| TBD | 1 byte | 2 bytes | 16 bytes | 16 bytes | 16 bytes |

where the command code indicates an authentication process, authentication type indicates that the authentication process is based on a shared secret, the Key ID is the pre-shared key used to encrypt the challenge R₁, the encrypted challenge R₁, the initialization vector, and the challenge R₂. The Key ID identifies the pre-shared key K_{PMK} that is used to encrypt the challenge R₁. Both Key ID and the shared key KPMK are initialized on device 110 during the commissioning process. The encrypted R₁ is f(K_{PMK}, R₁, IV), the challenge R₁ encrypted using the shared key K_{PMK} identified by the Key ID and the initiation vector IV. In some embodiments, the shared key K_{PMK}, the encrypted challenge R₁, and the initiation vector IV can be 16 bytes. The challenge R₂ is a high quality random number the same size as challenge R₁, for example 16 bytes.

Messages 208 and 308 can be transmitted in a frame, for example, given by

| | Authentication | | Encrypted | |
|---|---|---|---|---|
| Command code | Type | Key ID | challenge R₂ | IV |
| TBD | 1 byte | 2 bytes | 16 bytes | 16 bytes |

where command code indicates authentication, authentication type indicates authentication by mutually shared secret, the Key ID is the identification of the pre-shared key K_{PMK} used to encrypt the challenge R₂, the encrypted challenge R₂ is the encrypted R₂, and IV is the initiation vector. The transmitting device (reader 120 or tag 110) uses the same key ID that was utilized to encrypt challenge R₁ in messages 206 and 306, respectively. The encrypted challenge R₂ is provided by f(K_{PMK}, R₂, IV), which is the Tag's challenge encrypted using shared key K_{PMK} (PMK) and the initialization vector IV. As before, the encrypted challenge R₂ and the initialization vector IV can, for example, be 16 bytes in length.

Messages 210 and 310 can be transmitted in a frame, for example, given by

| | Authentication | Encrypted | |
|---|---|---|---|
| Command code | Type | Broadcast Key | IV |
| TBD | 1 byte | 16 bytes | 16 bytes |

where command code indicates authentication, authentication type indicates authentication by mutually shared secret, the encrypted broadcast key is the broadcast key encrypted, and IV is an initiation vector. The encrypted broadcast key is the broadcast key encrypted by the session key K_{S} and initialization vector IV, f(K_{S}, broadcast key, IV). In some embodiments, the encrypted broadcast key and the initialization vector IV can be 16 bytes in length.

Message 406 shown in FIG. 4 can be transmitted in a frame, for example given by

| | | | Encrypted | | Encrypted |
|---|---|---|---|---|---|
| Command | Authentication | | challenge | | Broadcast |
| code | Type | Key ID | R₂ | IV | Key |
| TBD | 1 byte | 2 bytes | 16 bytes | 16 bytes | 16 bytes |

where command code indicates authentication, authentication type indicates authentication by shared secret, key ID identifies the shared key K_{PMK} used to encrypt the challenge R₂, the encrypted challenge R₂ is the encrypted R₂, IV is the initiation vector, and encrypted broadcast key is the broadcast key encrypted. In this case reader 120 uses the same key ID that was utilized to encrypt challenge R₁ in messages 206 and 306, respectively. The encrypted challenge R₂ is provided by f(K_{PMK}, R₂, IV), which is the Tag's challenge encrypted using shared key K_{PMK} (PMK) and the initialization vector IV. The encrypted broadcast key is provided by f(K_{S}, Broadcast Key, IV), which is the broadcast key encrypted utilizing the shared key KS and the initialization vector IV. As before, the encrypted challenge R₂, the initialization vector IV, and the encrypted broadcast key can, for example, be 16 bytes in length.

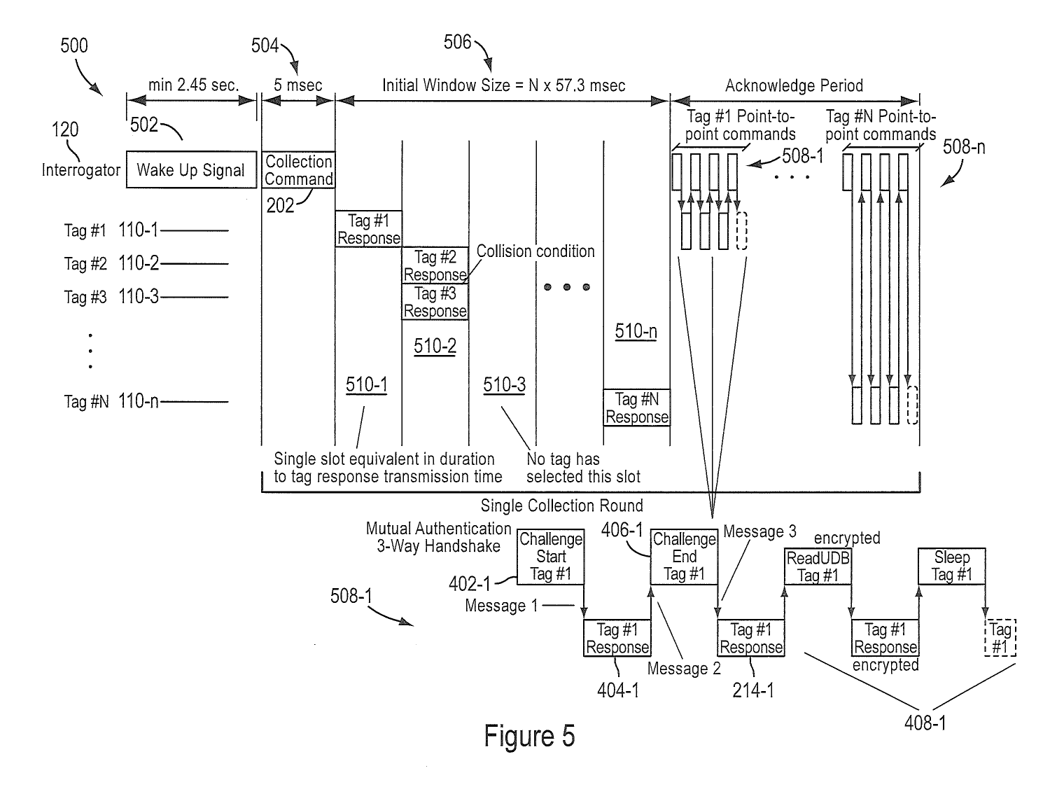

FIG. 5 illustrates an authentication process 500 that involves one reader 120 and multiple tags 110-1 through 110-n. Authentication process 500 is consistent with dialog 300 as shown in FIG. 3, although other dialogs as shown in FIGS. 2, 3, and 4 may be implemented.

As shown in FIG. 5, reader 502 first transmits a wake-up signal 502. Wake-up signal 502 is well known and further described in, for example, the Mode 2 application. Typically, the wake-up signal 502 is transmitted for a period of time, for example 2.4 sec, sufficient for tags 110-1 through 110-n to detect it. Tags 110-1 through 110-n, during a power down or sleep mode, activates periodically to check for a wake-up signal 502. In response to a wake-up signal, tags 110-1 through 110-n activate to detect further transmissions and interact with reader 502.

Once wake-up signal 502 is transmitted, reader 120 then transmits during time period 504 a collect command that may include message 202 can be transmitted. Message 202 can be transmitted as a frame, for example given by

| | variable | | | 8 bytes | 8 bytes |
|---|---|---|---|---|---|
| Command | Mutual | Friendly | Friendly | Timestamp | IV |
| | Authentication | Reader | Reader | | |
| | Type | Identifica- | String | | |
| | | tion | | | |

The command code includes a mutual authentication request and a collection command. The mutual authentication type identifies the types of authentication available, for example shared secret, certificate based, PKI based authentication, or user definable authentications. The friendly reader identification identifies reader 120 as a friendly reader and is a string of variable length. The friendly reader string is the “I am a friendly reader” identification string. The timestamp provides a time, as described above with message 202, and is, for example, of length 8 bytes. The payload of the frame, including the friendly reader identification, the friendly reader string, and the timestamp, may be encrypted and therefore an IV field is also included. Time period 504 can be, for example, 5 msec.

In time period 506, each of tags 110-1 through 110-n acknowledge the command provided in period 504. The acknowledgment frame may include a tag identification in a frame, for example, given by

| | | | |
|---|---|---|---|
| Command | Tag ID | Mutual Authentication | Encryption |
| | | Algorithms | Algorithms |

where Tag ID is the unique identifier for each of tags 110, mutual authentication algorithms provides a list of supported algorithms for mutual authentication, and encryption algorithms provides a list of supported encryption algorithms on tag 110. If tag 110 supports only one set of methods, reader 120 will record these values and use them for mutual authentication and secure data transfer. If tag 110 supports multiple methods, reader 120 may pick the first one in the list supported by reader 120. If reader 120 does not support any of the proposed protocols from tag 110, then reader 120 may ignore tag 110.

In the embodiment shown in FIG. 5, each of tags 110-1 through 110-n attempts to respond during one of time slots 510-1 through 510-n. As shown in period 510-2, collisions may occur and therefore arbitration procedures may be utilized. Each of periods 510-1 through 510-n can, for example, be of fixed time, for example. 57.3 msec. Arbitration procedures are described, for example, in the Mode 2 application. As such, each tag 110-1 through 110-n responds to the previous message (initial window of 57.3 msec) with the list of algorithms for mutual authentication supported as well as algorithms used for encryption and authentication of data frames.

In periods 508-1 through 508-n, reader 120 authenticates each of tags 110-1 through 110-n, tags 110-1 through 110-n being those that acknowledge in time period 406. In the example shown in FIG. 5, during periods 508-1 through 508-n utilize the three-way handshake illustrated in FIG. 4. As shown in FIG. 5, in period 508-1 message 402-1 is sent by reader 120, followed by message 404-1 sent by tag 110-1, followed by message 406-1 sent by reader 120. At which point, as discussed above, the tag 110-1 is authenticated with reader 120. Tag 110 may send ACK 214-1. Tag 110 and reader 120 can then transmit encrypted messages 408-1 between them. As shown in FIG. 5, reader 120 then moves to tag 110-2. The process continues until reader 120 has communicated with tag 508-n.

The challenge R₁ is a high quality random number, for example of length 16 bytes. The challenge R₁ sent to the 110-1 in period 508-1 can be different from the challenge R₁ sent to tag 110-2, and different from challenge R₁ sent to 110-n. Similarly, all of the challenges R₂ from each of tags 110-1 through 110-n are also different. In some embodiments, periods 508-1 through 508-n can include further interactions between reader 120 and tag 110, which can be encrypted after the authentication process is completed.

In some embodiments, both reader 120 and tags 110 (tags 110-1 through 110-n) may support PSK based mutual authentication. Furthermore, reader 120 and tags 110 may support AES-CBC encryption as described above and SHA-1 authentication. In cryptography, SHA-1 is a cryptographic hash function designed by the National Security Agency (NSA) and published by the NIST as a U.S. Federal Information Processing Standard FIGS. 180, which can be found at http://csrc.nist.gov/publications/fips/fips180-2/fips180-2withchangenotice.pdf, which is herein incorporated by reference in its entirety.

In some embodiments, a pre-shared key (PSK) can be of any length, for example 128 bits (16 bytes), or 32 octets when represented in hex. In some environments 100, a user may need to gain access to reader 120 or a server that communicates with reader 120. It is difficult for a user to correctly enter 32 hex characters. A user may utilize a pre-shared key to communicate with reader 120, and thereby gain access to tags 110. Most users, however, are familiar with passwords and pass-phrases and feel more comfortable entering them than entering keys. A user is more likely to be able to enter an ASCII password or pass-phrase, even though doing so limits the set of possible keys. This suggests that the best that can be done is to introduce a pass-phrase to PSK mapping. This pass-phrase mapping was introduced to encourage users unfamiliar with cryptographic concepts to enable the security features of their RFID domain. Keys derived from the pass phrase provide relatively lower levels of security, especially with keys generated from short passwords, since they are subject to a dictionary attack. Use of the key hash is recommended only where it is impractical to make use of a stronger form of user authentication. A key generated from a passphrase of less than about 20 characters is unlikely to deter attacks. The pass-phrase mapping described herein can, for example, use the Password-Based Cryptography Standard (PBKDF2) from PKCS #5 v2.0, which can be found at http://wwvv.rsasecurity.com/rsalabs/node.asp?id-2127.

Although the pre-shared key can be derived from a pass phrase in any fashion, in some embodiments the shared pass-key can be given by
PSK=PBKDF2(PassPhrase, “Savi Technology”, 15, 4096, 128),
   where PBKDF2 is a pseudo-random function (PRF) that hashes its inputs to derive a pseudo-random value. Pseudo-random functions are described for the HMAC-SHA1 at http://csrc.nist.gov/publications/fips/fisp198/fibs-198a.pdf and for SHA at http://csrc.nist.gov/publications/fibs/fibs180-3/fibs180-3_final.pdf. In this function, the pass-phrase can be a sequence of between 8 and 63 ASCII-encoded characters. The string “Savi Technology” can be replaced with an RFID domain name rfidDomainName if introduced. The length 15 represents the length of the string “Savi Technology” and can be replaced with the number of octets of RFID domain name rfidDomainName, if that is utilized. The number 4096 represents the number of times the pass-phrase is hashed. The number 128 is the number of bits output by the pass-phrase mapping.

The Unicast Session Key (K_{S}) can be derived in a number of ways. For example, K_{S} can be derived from the HMAC-SHA1 algorithm{. That algorithm can be given by

```
H-SHA-1(K, A, B, X) -> HMAC-SHA-1(K, A || Y || B || X)
PRF(K, A, B, Len)
for i < [symbol]  0 to (Len+159)/160 do
    R < [symbol]  R || H-SHA-1(K, A, B, i)
    return L(R, 0, Len)
PRF-128(K,A,B)=PRF(K,A,B,128)
Where A=R₁ and B=R₂
```

where Y is a single octet containing 0; X is a single octet containing the parameter; and ∥ denotes concatenation. A is given by challenge R₁ and B is given by challenge R₂.

In some embodiments, the Unicast Session Key K_{S} can be derived using SHA-1 or SHA-2. The algorithms for deriving K_{S} from SHA-1 and SHA-2. In some embodiments, the Unicast Session Key K_{S} can be given by
Ks=SHA1-128(R₁∥R₂∥S)
   where SHA1-128 is the first 128 bits of the argument list of the SHA, S is the shared secret, R₁ is the challenge R₁ (typically a random number generated by tag 110), and R₂ is the challenge R₂ (typically a random number generated by reader 120). The session key K_{S} is unique for the particular communications session between reader 120 and tag 110 and is generated from the same shared secret S.

The method for derivation of session keys using SHA1-128 may be less processor intensive and may be more suitable for a battery operated device such as tags 110. SHA-2 is a family of two similar hash function, with different block sizes, known as SHA-256 and SHA-512. They differ in word size, with SHA-256 using 32 bit words and SHA-512 using 64 bit words. There are also truncated versions of each standard, known as SHA-224 and SHA-384 that can be utilized. Each one of these standards is designed by NSA and published by NIST as described above. Any of the SHA-2 functions can be utilized for the session key derivation process, for example K_{S}=SHA256-128(R₁∥R₂∥S).

As shown in FIGS. 2, 3, and 4, messages 210, 310, and 406, respectively, a broadcast key used by reader 120 in the RFID domain can be sent to each tag 110 encrypted using unicast session K_{S} (Reader to Tag) key. Once mutually authenticated, reader 120 and tag 110 can then exchange encrypted data messages for as long as a session between them exists. Mutual authentication between a reader 120 and tag 110 may terminates when one of the following activities occur: reader 120 commands tag 110 to sleep using a Sleep or Sleep All But command; or tag 110 has not received a valid message for a period of time, for example 30 seconds, and transitions to the sleep state.

It is possible to keep a mutual authentication session between a reader 120 and tag 110 in effect longer in some embodiments. Although tag 110 can go to sleep multiple times, when awakened, if the collection process is started by the same reader 120 (the same reader id occurs in the collect message) and reader 120 does not explicitly request re-authentication, the three-way mutual authentication can be skipped and encrypted data traffic can be performed using the existing session keys for this tag 110 and reader 120. In this case the session key K_{S} can have a lifetime for example 30 minutes, 2 hours, or similar, and both sides keep track of mapping the peer address and session key. In some embodiments, the lifetime of the session key K_{S} can be a configurable parameter.

In some embodiments, instead of performing mutual authentication utilizing a shared secret, a mutual authentication performed utilizing public key infrastructure (PKI) can be performed. In PKI encryption, a public key refers to a cryptographic key used with a public key cryptographic algorithm that is uniquely associated with an entity and that may be made public. In an asymmetric (public) cryptosystem, the public key is associated with a private key. The public key may be known by anyone and, depending on the algorithm, may be used to: 1. Verify a digital signature that is signed by the corresponding private key; or 2. Encrypt data that can be decrypted by the corresponding private key.

A public key (asymmetric) cryptographic algorithm is an algorithm that uses two related keys, a public key and a private key. The two keys have the property that determining the private key from the public key is computationally infeasible. A public key infrastructure (PKI), refers to a framework that is established to issue, maintain, and revoke public key certificates.

A public key certificate refers to a set of data that uniquely identifies an entity, contains the entity's public key and possibly other information, and is digitally signed by a trusted party (for example a certified authority (CA)), thereby binding the public key to the entity. Additional information in the certificate could specify how the key is used and its crypto-period. A Digital Certificate typically includes the Owner's public key, Owner's name, Expiration date of the public key, the Name of the issuer (the CA that issued the Digital Certificate), the Serial number of the Digital Certificate, and the Digital signature of the issuer. The most widely accepted format for Digital Certificates is defined by the CCITT X.509 international standard. Certificates that conform to the X.509 standard can be read or written by any application complying with the X.509 standard.

The digital certificate is signed using the certificate issuer's (CA) private key. Everybody knows the certificate issuer's public key. Certificates are a standard way of binding a public key to a name. A digital signature scheme typically consists of three algorithms: A key generation algorithm that generates key pairs and outputs the private key and a corresponding public key; a signing algorithm which, given a message and a private key, produces a signature; and a signature verifying algorithm, which, given a message, public key, and a signature, either accepts or rejects the message's claim to authenticity. The scheme typically has two properties: First, a signature generated from a fixed message and fixed private key should verify the authenticity of that message by using the corresponding public key; and Second, it should be computationally infeasible to generate a valid signature for a party who does not possess the private key.

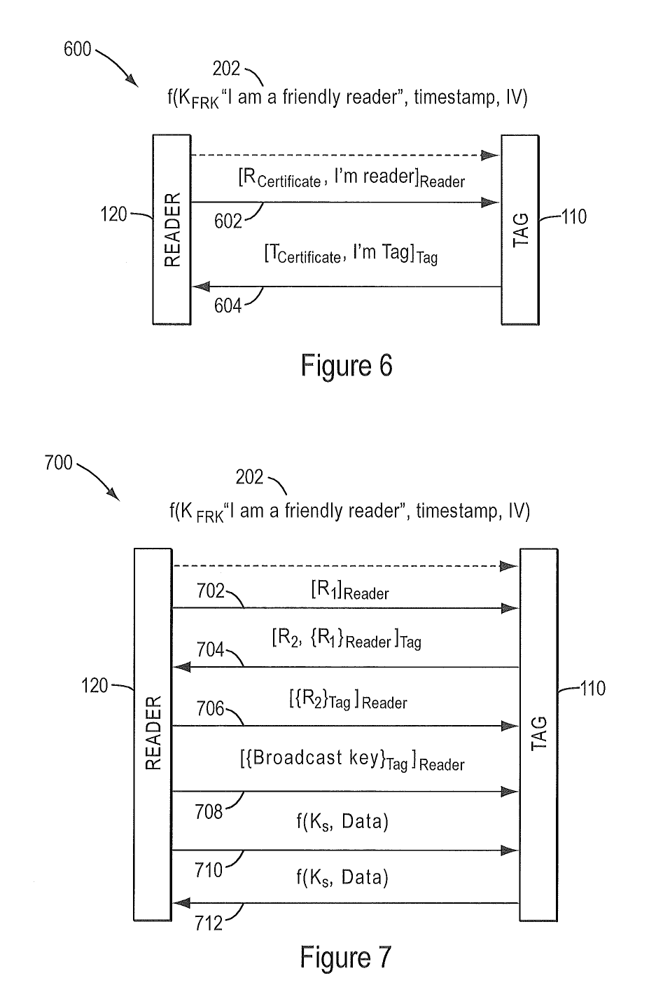

FIG. 6 illustrates a dialog 600 that involves a certificate exchange between reader 120 and tag 110. As shown in FIG. 6, reader 120 may send message 202. According to dialog 600, reader 120 then transmits message 602, which includes the certificate of reader 120 and may contain additional data. Tag 110 responds with message 604, which includes the certificate of tag 110 and further information. In dialog 600 shown in FIG. 6, signing includes encrypting a message digest with a private key ([X]_{private-key}).

In preparation of message 602, reader 120 creates a message digest by using a hash function on message 602. The message digest serves as a “digital fingerprint” of a message. If any part of the message is modified, the hash function returns a different result. Reader 120 then encrypts the message digest with its own private key. This encrypted message digest is the digital signature R_{Certificate} for message 602. Reader then sends message 602, which includes digital signature R_{Certificate} and message (“I'm reader”) to tag 110.

When tag 120 receives message 602, tag 602 decrypts the signature R_{Certificate} using the public key of reader 120, thus revealing the message digest. To verify the message, tag 110 then hashes the message with the same hash function reader 120 used and compares the result to the message digest it received from reader 120. If they are exactly equal, tag 110 can be confident that the message did indeed come from reader 120 and has not been changed. Because tag 110 uses reader 120's public key to verify the signature if the message digests are not equal, the message either originated elsewhere or was altered after it was signed.

Tag 110 can check reader 120's certificate signature using the CA public key. Tag 110 can then hash all data from the certificate to create the signature. Tag 110 can then decrypt the original cert signature using a public key. Tag 110 can then compare these two signatures. If they are the same the Reader certificate R_{Certificate} has not been forged. Tag 110 saves Reader 120's digital signature, which contains Reader 120's public key.

Message 604 sent by tag 110 contains tag 110's certificate and some additional data. The process of creating message 604, signing message 604, checking message 604, and creating the certificate of authenticity is the same as that followed by reader 120 to create message 602.

At the conclusion of dialog 600, then reader 120 and tag 110 have been authenticated to each other. In that case, both sides, reader 120 and Tag 110, have verified if a received certificate is valid and has not been forged. Further, reader 120 has its private and public key, its certificate signed with a private key of Certificate Authority (CA), CA certificate, and tag 110's certificate. Tag 110 similarly has its private and public key, its certificate signed with a private key of Certificate Authority (CA), a CA certificate, and reader 120's certificate.

FIG. 7 illustrates a dialog 700, which further shows a mutual authentication dialog 700 utilizing public keys. In dialog 700, signing the encryption utilizes one sides private key and then an encryption is performed with the other side's public key.

As shown in FIG. 7, message 702 is sent from reader 120 to tag 110. In message 702, reader 120 sends a challenge R₁, which is a random number, in the clear. The message is signed using reader 120's private key. When received by tag 110, tag 110 uses reader 120's public key to verify the signature.

Tag 110 then sends message 704. In message 704, tag 110 sends a challenge R₂, which is a random number, in the clear and challenge R₁ encrypted using reader 120's public key. Message 704 is signed using tag 110's private key. When reader 120 receives message 704, reader 120 uses tag 110's public key to verify the signature. Reader 120 then uses reader 120's private key to decrypt challenge R₁. If the decrypted challenge R₁ is the same as the original challenge R₁, then tag 110 is authenticated.

Reader 120 then sends message 706. Message 706 includes challenge R₂ encrypted utilizing tag 110's public key. Message 706 is signed by reader 120's private key. When tag 110 receives message 706, tag 110 can verify the signature utilizing reader 120's public key. Tag 110 then decrypts challenge R₂ using tag 110's private key and compares the challenge R₂ with the original challenge R₂ sent in message 704. If the decrypted challenge R₂ is the same as the original challenge R₂, then reader 120 is authenticated.

Unicast session (Reader 120 to Tag 110) key K_{S} can be derived the same way as described above utilizing SHA1 and challenges R₁ and R₂. Reader 120 can then send message 708, which includes the broadcast key, to tag 110 encrypted using Tag 110's public key.

Once reader 120 and tag 110 are mutually authenticated, they can exchange as many encrypted Data messages as needed. Only an authenticated tag can get the broadcast key from the reader. As shown in FIG. 7, messages 710 and 712, which are encrypted data, can be exchanged between reader 120 and tag 110.

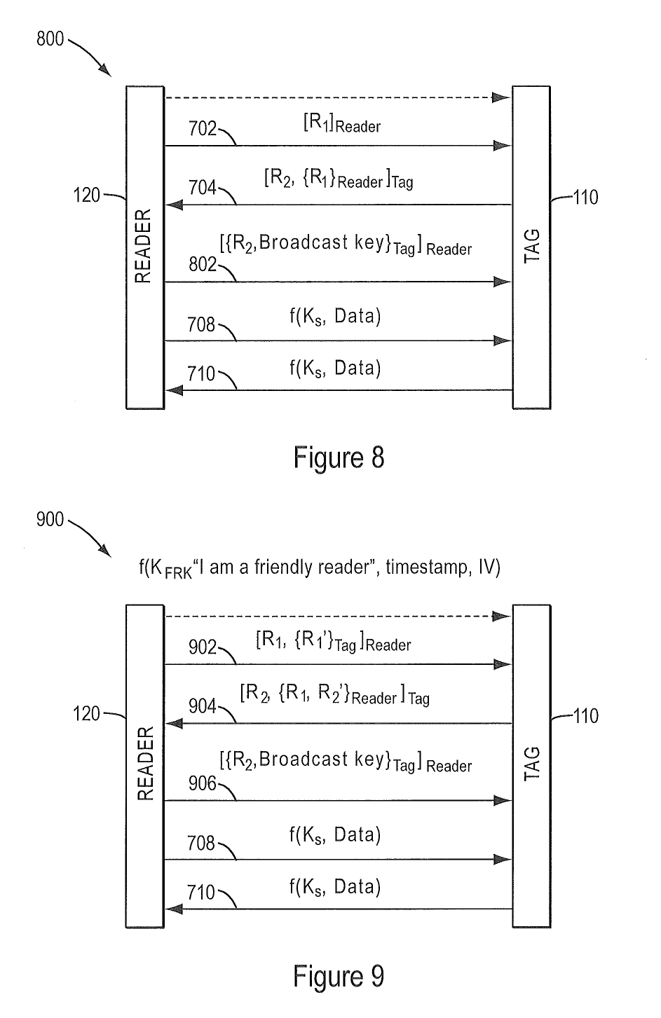

FIG. 8 illustrates dialog 800 that utilizes a three-way handshake for mutual authentication. As shown in FIG. 8, reader 120 sends message 702 and tag 110 responds with message 704, as described in FIG. 7. Reader 802 then sends message 802, which includes message 706 and message 708 shown in FIG. 7. In other words, it includes both challenge R₂ encrypted and the broadcast key encrypted using the tag 110's public key.

FIG. 9 illustrates a dialog 900 where challenges R₁ and R₂ are used for Mutual Authentication and challenges R₁′ and R₂′ are used for Key Derivation. As shown in FIG. 9, reader 120 first sends message 902, includes challenge R₁ in the clear and challenge R₁′ encrypted with tag 110's public key. Message 902 is signed using reader 120's private key. In message 904, tag 110 sends challenge R₂ along with R₁ and R₂′ encrypted with reader 120's public key. Message 904 is signed with tag 110's private key. In message 906, reader 120 transmits message 906, which is challenge R₂ and the broadcast key encrypted with tag 110's public key. Challenges R₁′ and R₂′ are used for session key derivation, for example using K_{S}=SHA1-128 (R₁′∥R₂′). In this case, It is possible to derive the session key K_{S} without any pre shared secret since both R₁′ and R₂′ are transmitted encrypted over the air.

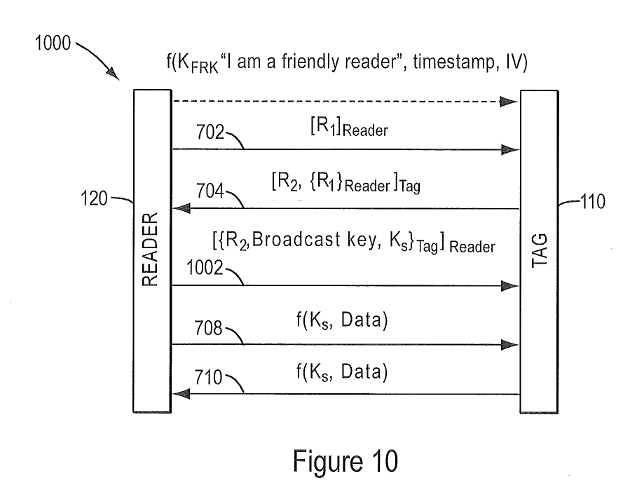

FIG. 10 illustrates another dialog 1000 for mutual authentication utilizing PKI. In this case, challenges R₁ and R₂ are used for mutual authentication through messages 702 and 704 as shown in FIG. 7. The key K_{S}, utilized to encrypt data in messages 708 and 710, is not generated from challenges R₁ and R₂. Instead, key Ks is generated by reader 120 and transmitted in message 120 as shown in FIG. 10. As shown in FIG. 10, message 1002 includes the challenge R₂, broadcast key, and key K_{S} encrypted with tag 110's public key. The signature utilizes reader 120's private key.

As shown in FIG. 6, PKI certificate exchange is utilized between reader 120 and one or more tags 110. Authentication message 602, and response message 604, can, for example, be transmitted as a frame with format

| | Authentication | | |
|---|---|---|---|
| Command code | Type | Certificate | Message Signature |
| TBD | 1 byte | TBD bytes | TBD bytes |

The certificate is reader 120's or tag 110's unique public key certificate that contains its identifying information and its public key. The message is signed by the certification authority (CA). As discussed above, when tag 110 receives the reader 120's certificate it first extracts reader 120's public key from the certificate. With this public key, tag 110 then decrypts the message signature to reveal the message digest. To verify the message, tag 110 then hashes the message with the same hash function that reader 120 used and compares the result to the message digest received from reader 120. If they are exactly equal, tag 110 can be confident the message 602 is authentic. If the message is authentic then tag 110 shall respond.

As before, the messages in dialogs 700, 800, 900, and 1000 are also sent utilizing MAC frames. Message 702, where reader 120 sends a challenge R₁ in the clear and signs the message utilizing reader 120's private key, can be transmitted, for example, utilizing the frame

| | Authentication | | |
|---|---|---|---|
| Command code | Type | Challenge R₁ | Message Signature |
| TBD | 1 byte | TBD bytes | TBD bytes |

where the command code includes a mutual authentication command, the mutual authentication type defines mutual authentication based on certificates (PKI), the challenge R₁ is a high quality random number, and the message signature is an encrypted message digest prepared with reader 120's private key. As discussed above, challenge R₁ can be 16 bytes in length.

As discussed above, in message 704 tag 110 sends a challenge R₂ in the clear, returns challenge R₁ encrypted with reader 120's public key, and signs message 704 with tag 110's private key ([R₂, {R₁}_{Reader}]_{Tag}). A frame format for message 704 can, for example, be given by

| | Authentication | Encrypted | | Message |
|---|---|---|---|---|
| Command code | Type | challenge R₁ | Challenge R₂ | Signature |
| TBD | 1 byte | 16 bytes | 16 bytes | TBD bytes |

where command code includes the command for mutual authentication, the authentication type identifies mutual authentication based on PKI, encrypted challenge R₁ is challenge R₁ encrypted utilizing reader 120's public key, challenge R₂ is a high quality random number not encrypted, and message signature is tag 110's message digest encrypted with tag 110's private key. As shown above, the encrypted challenge R₁ and the challenge R₂ can be 16 bytes in length.

As further shown in FIG. 7, reader 120 then sends message 706, which includes challenge R₂ encrypted utilizing tag 110's public key. Message 706 can be transmitted utilizing a frame, for example, given by

| | Authentication | Encrypted | |
|---|---|---|---|
| Command code | Type | challenge R₂ | Message Signature |
| TBD | 1 byte | 16 bytes | TBD bytes |

where the command code includes a command for mutual authentication, authentication type identifies authentication based on PKI, the encrypted challenge R₂ is challenge R₂ encrypted with tag 110's public key, and the message signature is the message digest with tag 110's public key. As shown, encrypted challenge R₂ is 16 bytes in length.

Message 708, where reader 120 transmits the broadcast key encrypted with tag 110's public key, can be transmitted with a frame format given by

| | Authentication | Encrypted | |
|---|---|---|---|
| Command code | Type | Broadcast Key | Message Signature |
| TBD | 1 byte | 16 bytes | TBD bytes |

again where the command code indicates mutual authentication, the authentication type indicates mutual authentication based on PKI, the encrypted broad key is the encrypted broadcast key using the session key K_{S} or, in some embodiments, utilizing tag 110's public key, and the message signature is signed utilizing the message digest with reader 120's private key.

Message 802, shown in FIG. 8, which includes a concatenated encrypted challenge f(K_{PMK}, R₂) and the encrypted broadcast key in one message, can be transmitted in a frame, for example, given by

| Command | Authentication | Encrypted | Encrypted | Message |
|---|---|---|---|---|
| code | Type | challenge R₂ | Broadcast Key | Signature |
| TBD | 1 byte | 16 bytes | 16 bytes | TBD bytes |

where the command code includes mutual authentication, the authentication type identifies the mutual authentication based on PKI, the encrypted challenge R₂ is tag 110's challenge R₂ encrypted using tag 110's public key, the encrypted broadcast key is encrypted utilizing the utilizing tag 110's public key, and the message signature utilizes reader 120's private key. As such, encrypted challenge R₂ and encrypted broadcast key can be 16 bytes in length.

Similarly, message 902 can be transmitted utilizing a frame, for example, given by

| | 1 byte | 16 byte | 16 byte | |
|---|---|---|---|---|
| Command | Authentication | Challenge R1 | Encrypted | Message |
| Code | Type | | Challenge R1′ | Signature |

where encrypted challenge R₁′ is challenge R₁′ encrypted utilizing tag 110's public key, and the signature utilizes reader 120's private key. Message 904 can be transmitted utilizing a frame, for example, given by

| | | | | | |
|---|---|---|---|---|---|
| Command | Authentication | R2 | Encrypted R1 | Encrypted | Message |
| code | Type | | | R2′ | Signature |

encrypted R₁ is challenge R₁ encrypted utilizing reader 120's public key, encrypted R₂′ is challenge R₂′ encrypted utilizing reader 120's public key, and message signature utilizes tag 110's private key. Message 906 can be transmitted utilizing a frame, for example, given by

| | | | | |
|---|---|---|---|---|
| Command | Authentication | Encrypted R2 | Encrypted | Message |
| code | type | | Broadcast Key | Signature |

where encrypted challenge R₂ is challenge R₂ encrypted tag 110's public key, encrypted broadcast key is the broadcast key encrypted with tag 110's public key, and the message signature utilizes reader 120's private key. Message 1002, shown in FIG. 10, can be transmitted utilizing a frame, for example, given by

| | | | | | |
|---|---|---|---|---|---|
| Command | Authen- | Encrypted | Encrypted | Encrypted KS | Message |
| code | tication | R2 | Broadcast | | Signature |
| | code | | Key | | |

where the encrypted challenge R₂ is encrypted utilizing tag 110's public key, the broadcast key is encrypted utilizing tag 110's public key, and the key KS is encrypted utilizing tag 110's public key. The message signature utilizes reader 120's private key.

Two methods of mutual authentication has been described above—mutual authentication by shared secret and mutual authentication by certificate. In accordance with some embodiments of the present invention, any mutual authentication method can be defined and utilized. The particular authentication utilized in a mutual authentication operation is identified in message frames with the authentication code. For example, code “00000001” can identify authentication by shared secret while code “00000010” can identify authentication by PKI. Any defined mutual authentication algorithm can be utilized. In some embodiments, a user can define its own authentication method. Setting a bit in the authentication code (for example bit 7) can indicate a user defined mutual authentication method.

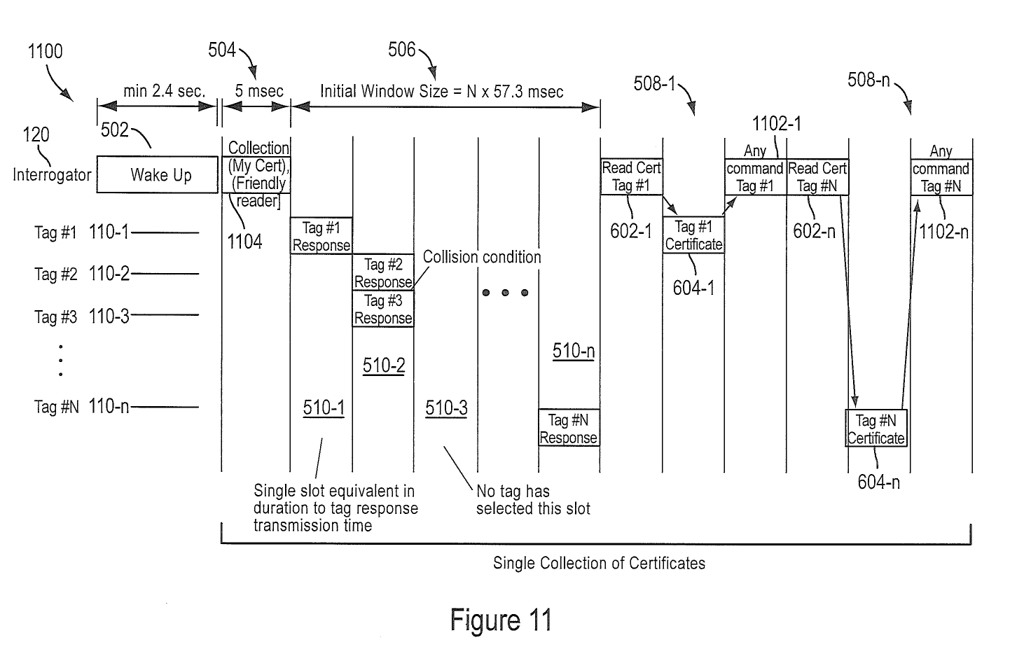

FIG. 11 illustrates mutual authentication utilizing certificates with multiple tags 110-1 through 110-n. As shown in FIG. 11, time period 502, 504, and 506 are implemented as described with FIG. 4. Time periods 508-1 through 508-n then provide dialog 600 as shown in FIG. 6, where messages 602-1 and 604-1 are shown in FIG. 6. Whereas FIG. 6 illustrates a single dialog between reader 120 and a single tag 110, FIG. 11 illustrates a dialog 1100 between reader 120 and multiple tags 110-1 through 110-n. Messages 1102-1 through 1102-n can then be any command from reader 120 to tag 110. Message 1104, similar to message 202, can provide a command for mutual authentication and identify the type of authentication utilized.

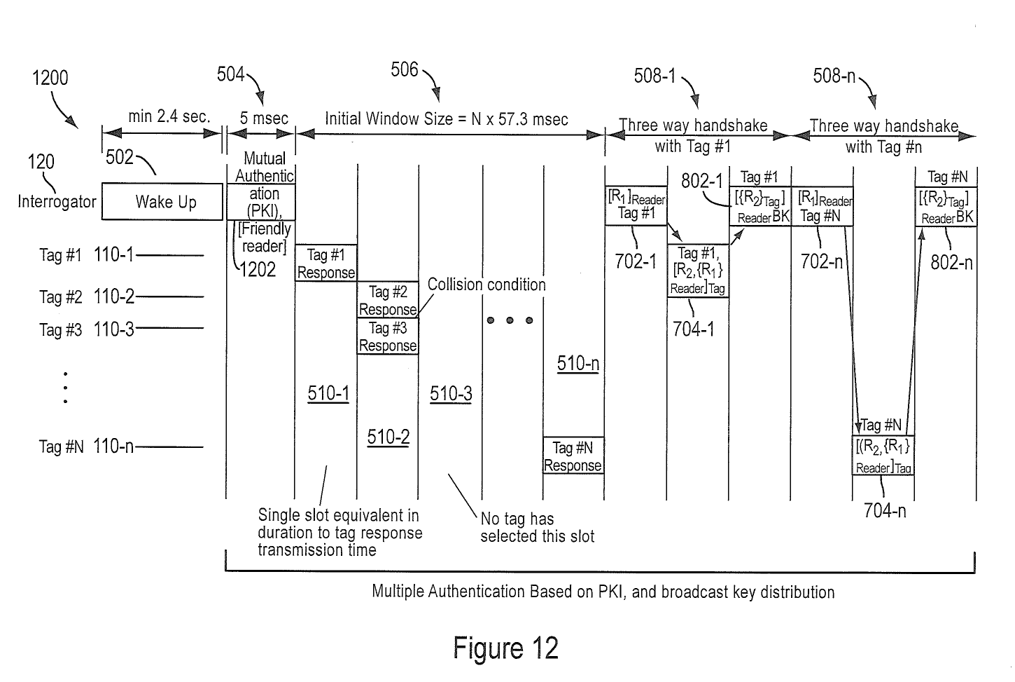

FIG. 12 illustrates authentication dialog 1200 between reader 120 and multiple tags 110-1 through 110-n. In this example, dialog 1200 implements dialog 800 shown in FIG. 8 with multiple tags 110-1 through 110-n. As shown in FIG. 12, message 1202 provided in time period 504 includes a command for mutual authentication and identifies PKI authentication. In some embodiments, the frame format for message 1202 may have the following fields: Mutual Authentication Request, Mutual Authentication Type (PSK or certificate based), Friendly Reader Identification, Friendly Reader Identification String and a timestamp.

Periods 508-1 through 508-n provides dialog 800 shown in FIG. 8. As discussed with respect to FIG. 5 above, because challenge R₁ is a high quality 16 byte length random number, the challenge R₁ sent to the tag 110-1 is different from the challenge R₁ sent to Tag 110-2, and it is different from the challenge R₁ sent to tag 110-n. The same statement is valid for the challenges R₂. Any of the dialogs illustrated above can be implemented with multiple tags 110-1 through 110-n. Once the mutual authentication is successful, reader 120 can perform collection or other functions through a secure link.

As shown above, PKI type messages as utilized in dialogs 700, 800, 900, and 1000 in FIGS. 7, 8, 9, and 10, respectively, utilize a signature certificate. Typically, there are three key types of algorithm that are utilized for digital certificates—RSA, digital signature algorithm (DSA), and elliptical code digital signal algoritym (ECDSA). Other signature algorithms that can be utilized include ECPVS (Elliptic Curve Pintsov Vanstone Signatures), which provides partial message recovery, ECQV (Elliptic Curve Qu Vanstone), an implicit certificate type and ECNR (Elliptic Curve Nyberg Rueppel), which provides full message recovery.

Although any secured signature format can be utilized, Eliptic Curve Cryptography (ECC) based signatures on a certificate are often smaller and faster to create than other options. The public key that the certificate holds may also be smaller than that of other signatures. Verification may also be faster using ECC-based certificates, especially at higher key strengths. The reason can be found in the basic math behind elliptic curves. The security of ECC systems is based on the elliptic curve discrete logarithm problem, rather than the integer factorization problem. This difference allows ECC systems to start out smaller, and scale more efficiently as the bit size of the matching symmetric key increases. Ultimately, this allows for faster computations and smaller key sizes for comparable security.

Table 1 below compares the performance of ECDSA over RSA for signing and verifying. The ECC and RSA signatures compared at each level are of equivalent strength, despite the difference in signature size. At all levels, which are NIST (National Institute of Standards in Technology) recommended key sizes, using ECDSA provides much higher performance benefits to both signing and verification operations than does either of RSA or DSA signatures.

TABLE 1
Signature Size for a 2000-bit Message

| Algorithm | Signature Size (bits) | Key Size (bits) |
|---|---|---|
| RSA | 1024 | 1024 |
| DSA | 320 | 1024 |
| ECDSA | 320 | 160 |

As illustrated in Table 1, one of the asymmetric algorithm types, elliptic curve cryptography (ECC), appears to be secure with shorter keys than those needed by other asymmetric key algorithms such as RSA and DSA. NIST guidelines state that ECC keys should be twice the length of equivalent strength symmetric key algorithms. So, for example, a 224-bit ECC key would have roughly the same strength as a 112-bit symmetric key. In addition, elliptic curve algorithms are capable of providing security consistent with AES keys of 128, 192, and 256 bits without extensive growth in asymmetric key sizes. Table 2, taken from Hoffman, P. a. (2000, August) “Determining strengths for public keys used for exchanging symmetric keys” and Lenstra, A. a. (n.d.). “Selecting cryptographic key sizes” http://www.cryptosavvy.com, gives approximate comparable key sizes for symmetric systems, ECC systems, and DH/DSA/RSA systems.

TABLE 2
Comparable key sizes

| Symmetric | ECC2N | ECP | DH/DSA/RSA |
|---|---|---|---|
| 80 | 163 | 192 | 1024 |
| 128 | 283 | 256 | 3072 |
| 192 | 409 | 384 | 7680 |
| 256 | 571 | 521 | 15360 |

As can be seen from Table 2, the ECC algorithm does provide a significant reduction in public key size. This reduction can become important in embodiments with severely constrained environments where large public keys may not be possible. However, in a PKI using X.509 certificates, the effect of using the smaller public keys is minimal. A typical size for an X.509 certificate would be about 1K (˜1000 bytes). Thus, changing a user's public key from RSA or DSA to ECC would reduce the certificate size by less than 10%. The details of X.509 v.3 certificates are included, for example, in the publication RFC 3280. In some embodiments, utilizing X.509 may not be suitable. In ISO 18000-7 protocol, for example, transferring a 1000 byte long certificate would require about 10 ISO 18000-7 frames. In order to use certificate based authentication and key derivation, a modified shorter version of a certificate may be supported. Since the size of a certificate depends on algorithms used for signing and encryption, some modified combinations may be more suitable.

In some embodiments, a modified X.509 certificate may, for example, include a serial number (6 bytes), an expiration date and certificate version (2 bytes), an ECC public key (32 bytes), and an ECC certificate signature (32 bytes). The two byte expiration data and certificate version field may include 5 bits for the year, 4 bits for the month, 5 bits for the day, and 2 bits for the version. This modified X.509 certificate can be developed from an ECDSA (ECC) X.509 v.3 certificate with an ECC signature (certificate signature generated using CA private key), resulting in a total certificate size of 72 bytes. This 72 byte size for the signature certificate may, for example, but suitable for the ISO 18000-7 (Mode 1) frame size. For the signature, besides the ECC based signature algorithm, SHA-256 encryption may be utilized.

In some embodiments, another certificate can be formed by using an RSA 2048 certificate with SHA1-RSA signature. In that case, the modified X.509 RSA 2048 based certificate can include a serial number (6 bytes), an experiation date and certificate version (2 bytes), an RSA 2048 public key (256 bytes), and a certificate signature (256 bytes). The size of this compact RSA 2048 certificate is 522 bytes. A modified RSA 3072 certificate can also be defined with these four data items, utilizing a 384 byte public key and a toal certificate size of 778 bytes.

In each of these certificates, the modified certificates includes all three types of data: public key, expiration date, and unique serial number. Besides having large keys and big certificates, RSA operations are CPU expensive and may not be appropriate for ISO 18000-7 (mode 1) type of equipment. In the mode 1 operation, the key size is too large, ISO 18000-7 mode 1 frames are too short, and RSA requires CPU power and large memories that may not exist on tags 110.

Cryptographic algorithms can be utilized to encrypt frames in any of the messages shown with FIGS. 1 through 11. Table 3 summaries some of these algorithms.

TABLE 3
Crypto Algorithms in Wireless Networks

| Algorithm | Description | Applications |
|---|---|---|
| SNOW 3G | Satisfies ETSI SAGE SNOW | Secure mobile |
| | 3G specification Outputs key | communications 3GPP |
| | stream in 32-bit data blocks | Long Term Evolution |
| | use 128-bit key and IV Small | (LTE) ISO standard |
| | size: from 7.5K ASIC gates | IS 18033-4 |
| Kasumi | ETSI SAGE specification | Secure mobile phone |
| | Block Cipher Algorithm | communications 3GPP |
| | Small size: from 5.5K ASIC | UMTS algorithms |
| | gates Processes 64-bit data | f8 and f9 |
| | blocks Use 128-bit key | |
| CCM6 | CCM—Counter Mode | WiMax - IEEE 802.16e |
| CCMP WPA2 | Encryption (CTR) operation | WiFi 802.11i CCMP |
| CCM* | with CBC MAC | IEEE 802.15.4 (ZigBee) |
| UWB MBOA | Small size: from 8,900 ASIC | UWB MBOA CCM |
| CCM | gates | |
| RSA Public | Implements the | Secure communications |
| Key | computationally demanding | systems; RFID Digital |
| cryptography | parts of RSA public key | Rights Management |
| | cryptography for long life | (DRM) for battery |
| | battery powered applications | powered electronics |
| | Support for RSA binary fields | |
| | of configurable bit sizes up to | |
| | 2048 | |
| Elliptic Curve | The operations necessary for | Secure communications |
| Cryptography | the ECC may not be | systems RFID |
| (ECC) | efficiently implemented on an | Implantable medical |
| | embedded CPU, typically | devices Digital Rights |
| | requiring hundreds of | Management (DRM) for |
| | milliseconds of the CPU | battery powered |
| | time for signature verification | electronics Elliptic Curve |
| | Small size: less than | Diffie-Hellman (EC-DH) |
| | 10K ASIC gates | standard ANSI X9.63 |
| | | Elliptic Curve Digital |
| | | Signature Algorithm |
| | | (EC-DSA) standard |
| | | ANSI X9.62 Digital |
| | | Signature Standard |
| | | (DSS) FIPS-186; B and |
| | | K elliptic curves (163, |
| | | 233, 283, 409, 571) |
| | | defined by NIST; IEEE |
| | | P1363 curves over |
| | | binary fields GF(2^{m}) |
| | | Zigbee SE Profile |
| PRNG | NIST publication SP800-90 | 802.11i, 802.15.3, |
| | Generates 128-bit data blocks | 802.15.4 (ZigBee), |
| | with 8, 16, 32, 64 or 128-bit | MBOA, 802.16e |
| | wide data interface Provides | Secure RFID Secure |
| | security strength of 128,192 | Smart Cards |
| | and 256 bits (6,500 gates) | |

The confidentiality and integrity of frames utilized to transmit messages as shown in FIGS. 2 through 11 can utilize these algorithms. The encryption can be utilized for securing the payload of the frames (Commands and command parameters) and can be utilized for securing both the addressing information (Session ID, Tag Manufacturer, and Tag ID) and the payload of the frames.

An encrypted frame of data for reader 120 to tag 110 in a broadcast protocol can, for example, be given by the frame

| | | | | | | Authentication | |
|---|---|---|---|---|---|---|---|
| | | | | IV/ | | Field | |
| Protocol | Packet | Packet | Session | CCM | Encrypted | SHA1-96\|SHA1\|CBC- | |
| ID | Options | Length | ID | Header | Payload | MAC | CRC |
| 0x50 | 1 byte | 1 byte | 2 bytes | 16/8 | N Bytes | 12\|20\|8 | 2 bytes |

where the protocol ID is, for example, consistent with the ISO 18000-7 Mode 1 or Mode 2 frame payload, the packet option is described below, the packet length provides the total length of the packet, the session ID provides the ID of the session, the IV/CCM header provides an initialization vector and CCM header, the encrypted payload is the encrypted frame, and authentication field can be the hash function result calculated over the payload prior to encryption, and a CRC field.

A frame that can be utilized from reader 120 to a tag 110 in point-to-point format can, for example, be given by

| | | | Tag | | |
|---|---|---|---|---|---|
| Protocol | Packet | Packet | Manufacturer | Tag Serial | |
| ID | Options | Length | ID | Number | Session ID |
| 0x50 | 1 byte | 1 byte | 2 bytes | 4 bytes | 2 Bytes |

| | | Authentication | |
|---|---|---|---|
| IV/ | | Field | |
| CCM | | SHA1-96\|SHA1\| | |
| Header | Encrypted Payload | CBC-MAC | CRC |
| 16/8 | N bytes | 12\|20\|8 | 2 bytes |

where the protocol ID, for example, is consistent with 18000-7, packet options is described below, the packet length provides the total length of the packet, the tag manufacturer ID identifies a particular one of tag 110, the tag serial number provides the serial number of the tag 110, the session ID identifies the particular session, the IV/CCM field provides either the initialization vector or the CCM header, the encrypted payload, the authentication field, and followed by a CRC field. This frame format provides privacy and authentication of the IS018000-7 frames, not including Tag and Session IDs, which are not encrypted. In this case, it is possible to have a unique key per tag. The Tag Serial Number and Tag Manufacturer ID, which are sent in the clear, are used to determine the record in a hash table so that tag 110's key can be easily retrieved. The size of the Authentication field depends on the selected authentication algorithms. In some embodiments, the crypto suites supported are those provided in Table 3. Replay protection can be initiated by enforcing the IV sequencing and removing the Sequence Number field from the frame.

Encrypting the payload and not the addressing information has the advantage that there can be a unique key per tag 110. Further, the Tag Serial Number and Tag Manufacturer ID can be utilized to determine the record in a hash table to easily retrieve tag 110's key without an extensive search. Further, the point-to-point messages need only be decrypted by the one of tags 110 that is identified by the Tag ID, which is sent in clear. However, the Tag ID and Session IDs are both sent in clear, only the payload is encrypted.

In some embodiments, the entire frame, which may be a ISO 18000-7 frame, can be encrypted and authentication using the Key ID. A frame format that can be utilized for secure reader 120 to tag 110 communications in both broadcast and point-to-point modes can, for example, be given by

| | | | | | | Authentication | |
|---|---|---|---|---|---|---|---|
| | | | | | | Field | |
| | | | | | | SHA1-96\| | |
| Protocol | Packet | Packet | KEY | IV/CCM | Encrypted | SHA1\|CBC- | |
| ID | Options | Length | ID | Header | Payload | MAC | CRC |
| 0x55 | 1 byte | 1 byte | 2 bytes | 16/8 bytes | N Bytes | 12\|20\|8 | 2 bytes |

where the fields have been described above. This frame format provides privacy and authentication of the frames. In this case, the Session ID, the Tag Manufacturer ID, the Tag Serial Number, as well as the message payload are encrypted and authenticated. The Key ID can contain the key index and a uniquely identify the key. The Key ID can be also a part of the initialization vector IV. In some embodiments, it is not possible to have a unique key per tag 110 (at least not for all of tags 110-1 through 110-n). A Key may be assigned for a group of tags 110 or it can be global. The Key ID will determine the key. There is no need for extensive search for the key. As before, replay protection can be done by enforcing IV sequencing and removing the Sequence Number field from the frame.

Encryption of both the payload and addressing information has the advantage that a complete frame including both the payload and addressing information is encrypted. Further, the Key ID is specified in the frame so that tag 110's key can be easily retrieved without an extensive search. Further, a single key may be assigned to a group of tag 110's. However, under this frame format it is only possible to have unique keys for some tags 110 but not for all tags 110because the Key ID field, being 2 bytes long, is not sufficiently long and the Tag ID and Tag Manufacturer ID are encrypted. Further, all point-to-point traffic has to be decrypted by all of tags 110-1 through 110-n and only the tag 110 with the same Tag Address and Manufacturer ID then processes the message. The other ones of tags 110-1 through 110-n drop the message.

In some embodiments, the entire frame can be encrypted and authenticated using a temporary tag ID. A secured reader 120 to tag 110 frame format for encrypting and authenticating an entire IS018000-7 frame using tag temp ID can be given, for example, by

| | | | | | | Authentication | |
|---|---|---|---|---|---|---|---|
| | | | Tag | | | Field | |
| Protocol | Packet | Packet | Temp | IV/CCM | Encrypted | SHA1-96\|SHA1\| | |
| ID | Options | Length | ID | Header | Payload | CBC-MAC | CRC |
| 0x55 | 1 byte | 1 byte | 2 bytes | 16/8 bytes | N Bytes | 12\|20\|8 | 2 bytes |

It is possible to define association process for the tags 110 in which they can send an association request frame to a reader 120. The reader 120 will assign an address, for example a 16 bit address, to each tag 110. Reader 120 then continues mapping the Tag ID with this temporary address. Reader 120 can then send an association response back to tag 110. After tag 110 is associated, all point-to-point frames between tag 110 and reader 120 contain the temporary address as presented in the above frame format. Original Tag Id and Tag Manufacturer ID may be a part of the encrypted payload and their privacy may be guaranteed after the association procedure. In this case, it is possible to have a unique key per tag, while continuing to keep the Tag ID and Tag Manufacturer ID secured.

Encryption of both the payload and address information can be beneficial. The complete frame, including both the payload and the address information, is encrypted (e.g., the Tag ID and the Tag Manufacturer ID are both encrypted). The Temporary Tag ID is specified in the frame so that Tag 110's key can be easily retrieved with no extensive searches. Utilizing this frame format, it is possible to have a unique key for multiple keys, with two bytes up to 2¹⁶ tags 110 in one RFID security domain. The point-to-point traffic, then, has to be decrypted only by the one tag 110 that is addressed, the other tags 110-1 through 110-n can drop the message without decryption. However, the association process to assign the temporary keys and associate those keys needs to be defined and implemented. During the association process, both Tag ID and Tag Manufacturer ID may be sent in clear.

The MAC frames described above all have a packet options field. The packet options field, for example, can be given by

BITS

| | 6 | 5 | 4 | | | | |
|---|---|---|---|---|---|---|---|
| | Protection suites | | | | | | |
| 7 | See Error! Reference | | | 3 | | | |
| PKI | source not found. | | | Secure bit | 2 | 1 | 0 |
| 0 = PKI | | | | 0 = Frame is not | 1 | 0 = Broadcast (Tag serial | Reserved |
| not used | | | | encrypted (there is no | | number and Tag | |
| 1 = PKI | | | | IV and authentication | | manufacturer ID not present) | |
| used | | | | field in the frame) | | 1 = Point to Point (Tag serial | |
| | | | | 1 = Frame is encrypted | | number and tag manufacturer | |
| | | | | | | ID present) | |

The Packet Options field Bit 3 can be used to indicate if the frame is secured or not. If the value of bit 3 is set to 1, then the frame is secured and the frame includes the Key ID, IV and Authentication fields. If bit 3 is set to 0, then the frame is not secured and the frame does not include the KEY ID, IV, Sequence Number and Authentication fields. The command code and command arguments can be sent in the clear.

In some embodiments, the protection suites can include symmetric cryptography. Cryptographic protection of the messages consists of an optional message encryption step followed by a message authentication step. Each protection suite type is assigned an enumerated descriptor also called a protection suite identifier. A protection suite identifier can be written as a designator of an encryption method followed by a designator of an authentication method, e.g. <message-encryption-method->-<message-authentication-method>. The protection suite descriptor uniquely identifies the methods used to authenticate and encrypt the message. Table 4 shows a sampling of crypto protection suites.

TABLE 4
ISO 18000-7S Protection Suites

| | | | | | | | Packet |
|---|---|---|---|---|---|---|---|
| | | | | | | | Options |
| Protection | | Key | | | | | (Protection |
| Suite | Encryption | Size, | Encryption | Authent. | Authent. | | suites |
| Descriptor | Algorithm | bit | Mode | Algorithm | size, bit | Frame overhead | bits) |
| AES-128- | AES | 128 | CBC | SHA1-96 | 96 | IV + Auth + Payload | 001 |
| CBC-SHA1- | | | | | | Padding = 8 + 12 + (0 | |
| 96 | | | | | | to 15) = from 20 to | |
| | | | | | | 35 bytes | |
| AES-128- | AES | 128 | CBC | SHA1 | 160 | IV + Auth + Payload | 010 |
| CBC-SHA1 | | | | | | Padding = 8 + 20 + (0 | |
| | | | | | | to 15) = from 28 to | |
| | | | | | | 43 bytes | |
| CCM-7 | AES | 128 | Counter | AES- | 64 | CCM Header + | 011 |
| (CCM for | | | | CBC- | | MIC = 8 + 8 = 16 | |
| ISO 18000-7) | | | | MAC | | bytes | |
| NULL-NULL | None | N/A | N/A | None | N/A | NONE | 000 |
| (secure bit is 0) | | | | | | | |

Use of AES-128-CBC-SHA1-96 encryption is an AES CBC FIPS certified algorithm. SHA1-96 is still accepted by NIST for FIPS certification, however it is scheduled to be phased out. Additionally, payload padding is required by AES-CBC. SHA1-96 adds 12 bytes of overhead. For example, the SHA1 result may be about 160 bits with the first 96 bits utilized for authentication. Further SHA1 is performed in software. AES-128-CBC-SHA1 is also an AES CBC FIPS certified algorithm, however SHA is scheduled to be phased out. AES-128-CBC-SHA1 also requires padding of the payload, is performed in software, and adds 20 bytes of overhead. CCM-7 is a standard encryption algorithm that is utilized in both IEEE 802.11i and ZigBee protocols.

CCM-7 is based on CCM, a generic authenticated encryption block cipher mode of AES. CCM is a mode of operation defined for any block cipher with a 128-bit block size. CCM combines two well-known and proven cryptographic techniques to achieve robust security. First, CCM uses CTR for confidentiality and Cipher Block Chaining MAC (CBC-MAC) for both authentication and integrity protection. The CCM-7 key space has size 2¹²⁸ and uses a 48-bit packet number (PN) to construct a nonce to prevent replay attacks. The construction of the nonce allows the key to be used for both integrity and confidentiality without compromising either. The CCM was specifically designed to possess the following characteristics: A single cryptographic key for confidentiality and integrity to minimize complexity and maximize performance (minimize key scheduling time); Integrity protection of the packet header and packet payload, in addition to providing confidentiality of the payload; Small footprint (hardware or software implementation size) to minimize costs; Small security-related packet overhead (minimal data expansion due to cryptographic padding and integrity field, for instance); and No encumbrance by any existing or pending patents.

When PKI is used, the PKI bit in the Packet Options field is set to 1. Protection suite bits will then code the PKI algorithm used for mutual authentication, for example 0001 for ECC or 010 for RSA. In some embodiments, when authentication and encryption is not utilized, then the MAC frames are backwards compatible with previous protocol generations. For example, authentication and encryption may be added to 18000-7 mode 1 and, when not in use, the MAC frames are compatible with unsecured 18000-7 mode 1 packets.

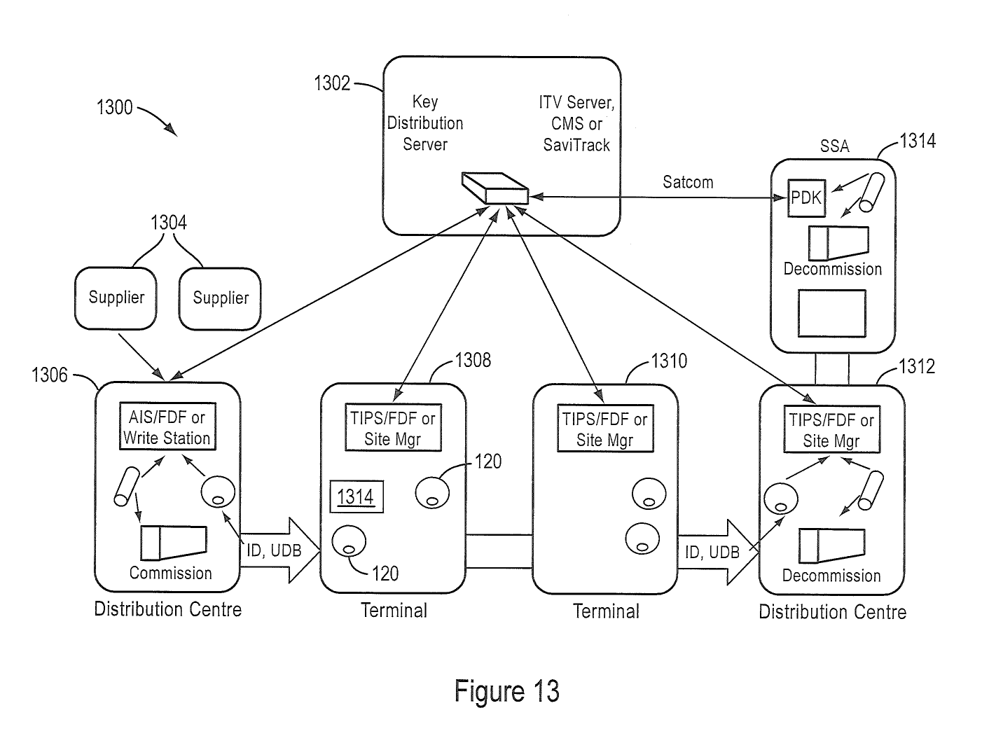

FIG. 13 illustrates an example use environment 1300 for tags 110 according to some embodiments of the present invention. The use environment includes Key generation, Key distribution, Tag Commissioning, Tag Decommissioning, Key update of the RFID signpost and readers at each RFID domain site, Key update of handheld devices used at SSA, Rekeying, and Mutual Authentication. As shown in FIG. 13, environment 1300 can include a key distribution server 1302, a distribution center 1306, a terminal 1308, a terminal 1310, a distribution center 1312, and a decommissioning center 1314. Distribution center 1306, terminal 1308, terminal 1310, distribution center 1312, and decommissioning center 1314 are all in communications, for example through a satellite link or an internet link, to key distribution center 1312. As is illustrated with regard to terminal 1308, each site (distribution center 1306, terminal 1308, terminal 1310, and distribution center 1312) may include a central server 1314 that communicates with multiple readers 120. As discussed further below, a tag 110 entering terminal 1308 may establish a secured link with individual readers 120 as discussed above, or may establish a secured link with server 1314 (and thus every reader 120 in terminal 1308) through one of readers 120.

Key Distribution Server 1302 can be implemented as a module running on the ITV, CMS or SaviTrack Servers, which are RFID application servers. A security officer, authenticated and logged into the Key Distribution Server 1302, can initialize the keys utilized in readers 120 and tags 110 for a shipment from the starting commission point at distribution center 1306 to the end decommission point at decommission center 1314. In some embodiments, the security officer can request to obtain Pair-wise Master Keys (PMK) for each RFID domain in a shipment, which can include Port of Loading, Port of Unloading, Terminal, distribution centre, customs inspection point, SSA or other point. The example shown in FIG. 13 includes distribution center 1306, terminal 1308, terminal 1310, and distribution center 1312. The Security officer at server 1302 can perform several function, including getting the same set of PMKs for all RFID Domains for a shipment, getting a completely different set of PMKs for each of the RFID Domains for a shipment, and selecting encryption and authentication schemes used at each of the RFID domains. Key Distribution Server 1302 can then distribute relevant keys to the servers in charge of the RFID domains (Site Manager, Write Station, AIS/FDF, TIPS/FDF, PDK etc.) via a secure protocol (SSH, SFTP or HTPPS based). TIPS/FTF is a Device Framework software library which offers a common interface for configuring devices and capturing events from them. It provides a uniform way to access all devices and abstracts the physical properties from the users.

As shown in FIG. 13, server 1302 distributes appropriate keys to each of distribution center 1306, terminal 1308, terminal 1308, and distribution center 1310. In some embodiments, site keys may be distributed once and tags 110 for each shipment are appropriately loaded.

All the keys and other Critical Security Parameters (CSPs) may be distributed in an encrypted form. An operator at the receiving RFID domain site does not have to know the PMKs. The Key Table may contain the a KEY ID (2 byte), an encrypted KEY (128 bit), encryption and authentication algorithms, and a KEY description. Key Distribution Server 1302 provides a relevant part of the Key table to the handheld, portable deployment kit readers, signpost readers, or any other readers at each RFID domain (each of distribution 1306, terminal 1308, terminal 1310, and distribution 1312 represents an individual RFID domain) via available communication links, which may include internet, wireless, or satellite links.

Distribution center 1306 receives articles to be shipped from suppliers 1304, commissions tags 110, and ships the articles with attached tags. The active RFID tag 110 can be commissioned by ordinary means. A security officer or administrator at distribution center 1306 can be authenticated with a Write Station or AIS/FDF using a username and password. The manifest of a shipment can be downloaded into tag 110 using Write Station software, for example through serial port. A portion of the key table received from Key Distribution server 1302 containing Critical Security Parameters (CSPs) is then downloaded into tag 110 using Write Station software through serial port. Tag 110 is then installed on a container that includes the articles, and the container is sealed. A command is sent to RFID tag 110 to “lock” itself. In some embodiments, any attempt to open the door of a container without electronically unlocking the tag results in a tamper condition.

The number of the keys programmed into each of tags 110 depends on the particular type of deployment. In the simplest scenario only one key is programmed into each tag 110. This key will be used as a Pair-wise Master Key from commissioning to decommissioning of tag 110. In more realistic scenarios, multiple Pair-wise Master Keys can be programmed into each tag 110. Once all of the RFID tags 110 are commissioned and keys are downloaded, a report with the list of tag IDs with corresponding key IDs can be sent to Key Distribution Server 1302, in some cases via a secure protocol. In some embodiments, the key IDs can be written into the manifest of each tag 110.

As tag 110 leaves distribution center 1306, a signpost reader generates a gate-out read event. In some cases, the license plate (LP) data and the User Data Block (UDB) can be forwarded to ITV, CMS or SaviTrack server 1302 depending on deployment. In some embodiments, the Key Distribution Server 1302 provides a relevant part of the Key table to the signpost readers at distribution center 1306 on time so the first secure RFID transaction can be performed at distribution center 1306.

Once tag 110, along with the articles to which it is attached, leaves distribution center 1306, it arrives at terminal 1308. At loading terminal 1308, tag 110 can interact with further RFID secured areas as it enters terminal 1308. At terminal 1308, the container and tag 110 can be loaded onto either commercial ocean carriers or military vessels depending on the type of cargo and the stage of operation. The vessel then arrives at terminal 1310 with tag 110.

Port terminals such as terminals 1308 and 1310 can employ RFID infrastructure at the gates and docks. Key Distribution Server 1302 provides a relevant part of the Key table to the RFID readers in the port of loading terminal 1308 and point of unloading terminal 1310 via Site Manager or TIPS/FDF on time software. A gate-in read by a signpost/reader decrypts and passes LP and UDB data to the CMS server via Site Manager or to the ITV server via TIPS/FDF. Such data may be uploaded to key distribution center 1302. There may be additional readers in the container yard and at the dock at terminals 1308 and 1310 which may be used to monitor enhanced data such as sensors.

In some cases, the container will be inspected by customs officials at either terminal 1308 or terminal 1310. Using a handheld reader 120, the customs official can download the manifest from the user memory portion of tag 110 and match to the manifest electronically transmitted with the ASN. The customs inspector can also verify that the container has not been tampered or opened during transportation. Again, the Key Distribution Server 1302 provides the relevant part of the Key table to the customs officials needed for RFID handheld readers.

Typically, there is no RFID activity aboard the cargo ship between terminal 1308 and terminal 1310. Additionally, there is typically no RFID activity aboard trucks, ships, or other conveyance. Therefore, there is typically no communications between Key Distribution server 1302 to conveyance.

When the articles along with associated tags 110 reach the port of unloading at terminal 1310, a gate-in read of ID+UDB can be generated. These read events, which include LP and UDB, are sent to the ITV, CMS or SaviTrack server at Key Distribution Server 1302 via TIPS/FDF or Site Manager. Key Distribution Server 1302 provides a relevant part of the Key table to the signpost readers in terminal 1310 via Site Manager or TIPS/FDF on time so the readers 120 can communicate with RFID tags 110.

Once leaving terminal 1310, the article and associated tag 110 is shipped to distribution center 1312. Theater distribution centers 1312 can have reliable Internet connectivity and can perform cross-docking of container loads. Distribution center 1312 can have RFID readers installed at the gates, typically polling tag 110. Key Distribution Server 1302 provides relevant parts of the Key table to the signpost readers at distribution center 1312 on time. Distribution center 1312 can have the same RFID capabilities as distribution center 1306 for commissioning or decommissioning tag 110 and connectivity to Key Distribution Center 1302.

As shown in FIG. 13, distribution center 1312 may include decommission center 1314. A security officer, who has been authenticated with a write station or AIS/FDF using username and password, can zeroize tag 110 using Write Station software, for example through a serial port. A report of the decommissioning can be sent to Key Distribution Server 1302 to report decommission RFID tags 110. In some embodiments, distribution center 1312 may commission previously decommissioned RFID tags 110 as described with distribution center 1306.

In some embodiments, each of tags 110 may meet the following FIPS 140-2 Level 4 requirements. Accordingly, penetration of the cryptographic module enclosure of tag 110 from any direction has a very high probability of being detected; resulting in the immediate zeroization of all plaintext CSPs. Security Level 4 cryptographic modules are useful for operation in physically unprotected environments. Some tags 110, however, may have other security requirements.

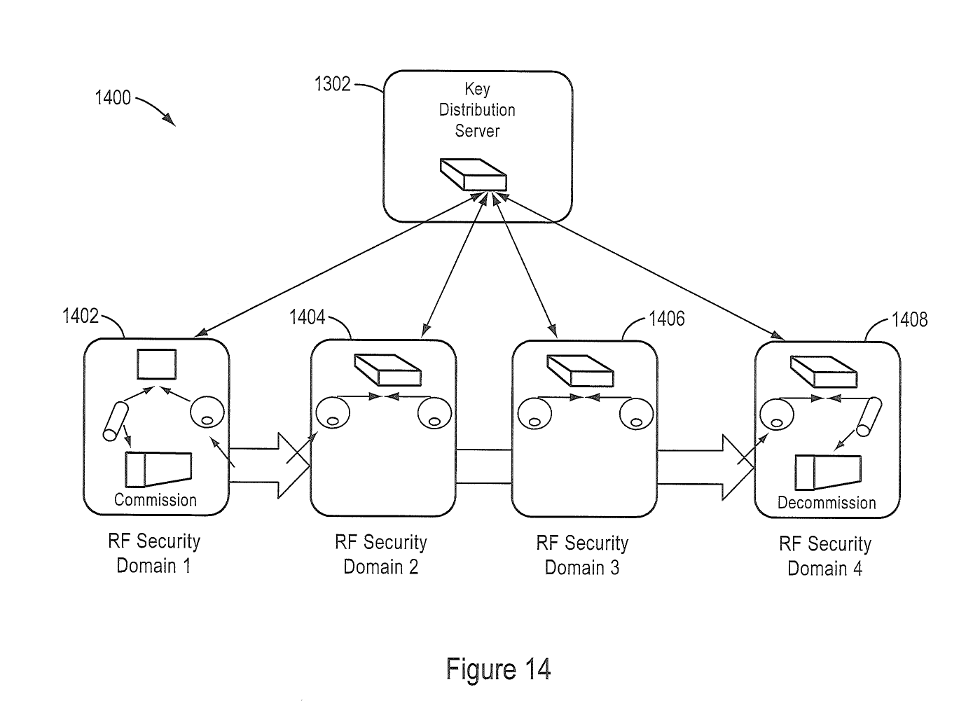

FIG. 14 illustrates a mobility access 1400. As shown in FIG. 14, mobility access 1400 illustrates infrastructure to support the key management for mobile tags 110 that are mobile between secure RFID domains. Secured RFID domains 1402, 1404, 1406, and 1408 are shown in FIG. 14. The secure configuration can be initially shared by readers 120 and tags 110 as a part of an extended commissioning process of each of security domains 1402, 1404, 1406, and 1408. To support mobility of tags 110 between secure RFID domains, the secure configuration has to be propagated to all of the secure RFID domains 1402, 1404, 1406, and 1408. Key Distribution Server 1306 facilitates provisioning of the secure configuration to all fixed and mobile RFID reader infrastructure.

Key Distribution Server 1306 can configure tags 110 by any method, including by serial connection or by UHF/LF wireless interface. Key Distribution Server 1306 can commission a tag 110 through a serial interface connecting tag 110 to a docking station. The security configuration can be performed as a part of existing commissioning process using a Write Station at each of domains 1402, 1404, 1406, and 1408. A security officer, who can be authenticated by the Write Station, can facilitate the tag commissioning process. Transmitting the security configuration to the tags 110 through a serial interface can be a secure method.

In some embodiments, commissioning can be performed utilizing a UHF/LF wireless method. A wireless method can be vulnerable if not performed in a physically secured environment. After the existing commissioning process is done using the Write Station, the transfer of the security configuration can be performed over the air using UHF or LF. UHF can be used in an RF chamber for example. LF can be used at a signpost, for example. It should be easier to physically secure LF than UHF. Since communication between readers 120 (fixed RFID infrastructure) and tags 110 will be in the clear during the upload of the secure configuration over the air using UHF/LF, it is important to define a procedure that guarantees physical security of the RFID domain (one of domains 1402 through 1408) during the process. If it is not possible to guarantee physical security of the RFID domain, then upload of the secure configuration should be performed through the serial interface. In some embodiments, new commands, for example in ISO 18000-7, can be provided to upload the Security Configuration (“Upload Secure Configuration” command) into a tag 110. Also, new commands for the LF communications can be provided.

Key Distribution Server 1302 also can provision the secure configuration to the fixed RFID reader 120 infrastructure through a secure communication protocol. In some embodiments, Secure File Transfer protocol (SFTP) can be used for this purpose. In a non fixed RFID domain where handheld readers are used, the Portable Deployment Kit (PDK) can upload the secure configuration from the Key Distribution Server 1306 over a secure link. Since this link can be IP enabled, Secure File Transfer protocol (SFTP) can also be used for secure configuration transfer. The handheld reader can be physically connected to the PDK in order to obtain the secure configuration.

During the commissioning process an RFID tag 110 can be programmed with the Key Table, which may contain a record (PMK ID, key, encryption algorithm, authentication algorithm) for each RFID domain 1402, 1404, 1406, and 1408 that tag 110 will be associated with between the commissioning and the decommissioning steps. This key can be the Pair-Wise Master Key K_{PMK} used for mutual authentication and session key derivation process described above. In some embodiments, all RFID domains 1402, 1404, 1406, and 1408 are not known at the commissioning time, so additional procedures can be provided for updating this table.

During the commissioning process an RFID tag 110 may be programmed with the Routing Key Table, which will contain the PMK (K_{PMK}) for each RFID hop (transport between RFID domains 1402, 1404, 1406, and 1408. Tag 110 may always know its current hop PMK Key ID as well as that from the next domain and the previous domain. As shown in FIG. 14, if tag is in security domain 1404, it is loaded with the appropriate keys for domain 1402, from which tag 110 came, and to domain 1408, to which tag 110 is going next.

During the commissioning process, RFID tag 110 canl be programmed with a Secure Mode Flag. If the security is enabled the Secure Mode Flag will be set to ON, otherwise it will be reset. If the Secure Mode Flag of a tag 110 is set to ON, tag 110 will not send or receive any messages in the clear.

Once tags 110 are about the leave an RFID domain, for example RFID domain 1404, a Reader 120 within that domain may send a new message “Next Hub PMK ID” to all tags 110 encrypted with broadcast key. Once tag 110 receives this message, tags 110 will be ready to communicate back (mutually authenticate) using the next hop key with the next domain, for example domain 1406. This implies that current Key ID on a tag 110 becomes the Next Hop Key ID. In some embodiments, if tag 110 initiates an Alarm message, it may always be sent using the current session key.

The current hop key ID for a tag 110 can, in some embodiments, be updated. The LF communication between a signpost reader 120 and a tag 110 can be extended with a new command to provide the PMK Key ID of the new RFID domain to tags 110.

If a tag 110 is being re-routed to a new RFID domain that was not known during the commissioning procedure, then the security information in tag 110 can be updated either before leaving for the new RFID domain and or may be updated when it arrives at the new domain. In FIG. 14, for example, tag 110 may be updated in domain 1404 for keys appropriate for domain 1406 or may be updated in domain 1406 when tag 110 arrives.

If tag 110 has already moved to the new RFID domain 1406, Key Distribution Server 1302 can deliver the broadcast key of the previous RFID domain 1404 to the RFID reader 120 in the new RFID domain 1406. Reader 120 can then use an “Add New PMK” command encrypted with this broadcast key to transfer the PMK K_{PMK} of the new RFID domain 1406 to the newly arrived tags 110.

If tag 110 has not yet moved to new RFID domain 1406 from previous RFID domain 1404, Key Distribution Server 1302 can deliver the PMK K_{PMK} of the next hop, domain 1406, to a Reader 120 in the existing RFID domain 1404. Reader 120 can then send an “Add New PMK” command encrypted with its own broadcast key to tags 110 so that all tags 110 that are being sent to domain 1406 will add the new PMK ID into their Key Tables.

In some embodiments, creation of a new broadcast session key can be initiated. In some embodiments, a reader 120 can initiate a process of creation of a new broadcast session key or rekeying existing broadcast session key. In some embodiments, reader 120 can generate a high quality random number and additional seed and use it as the broadcast key. In some embodiments, a Security Officer can enter the broadcast key using a console at a domain. The security officer may be properly authenticated with the system at the domain. In some embodiments, a broadcast key can be obtained from Key Distribution Server 1302. In some embodiments, a new broadcast key can be generated with an input seed received from tags 110.

Reader 120 can broadcast a request, a “New Broadcast Session Key Request,” that may be piggy-backed an an existing collection process. Tags 110 can respond with Nonce values, which can be used for deriving a new broadcast session key. Distribute the new broadcast session key and its Key ID to all tags 110 can be performed in an encrypted broadcast message, a “New Broadcast Session Key”. This message may be encrypted using the broadcast key which is going to be replaced. In some embodiments, the broadcast key can be transferred to tags 110 after successful mutual authentication as described above. In this case the distribution of broadcast is done using unicast (point-to-point) message to tag 110. One tag 110 is updated at a time.

In some cases, tags 110 may be moved from a secured domain such as domain 1404 to an unsecured domain. It is possible that a tag 110 is moving between RFID domains and security is enabled in some and but not in all of the domains. For this purpose, a “Set Secure Mode” command can be sent to tags 110 encrypted using the broadcast key and it can set the secure mode in an RFID domain to ON or OFF. In order to turn off the secure mode, reader 120 has to know the broadcast key. The customer deployment policy at any of domains 1402, 1404, 1406, or 1408 may disallow the use of this command.

In some embodiments, a “Delete a PMK” Command can be provided. This command may always be sent encrypted and specifies which PMK ID to be deleted from tag 110. The “Delete a PMK” command may be used when a tag is leaving an RFID domain and the “Next Hop Key ID” command is sent. For example: “Next Hop Key ID”=100; “Delete a Key”:55. As a result the tag 110 leaving the RFID domain will destroy (zeroize) and a copy of the PMK ID will be written. This command may be useful to free memory storage in tag 110, especially if tag 110 will never come back to this particular RFID domain.

In some embodiments, a “Purge Routing Key Table” command can be utilized to wipe out the routing PMK Table for tags 110 at a particular RFID domain. This may be done for security reasons, for example if security has been breached at a particular security domain.

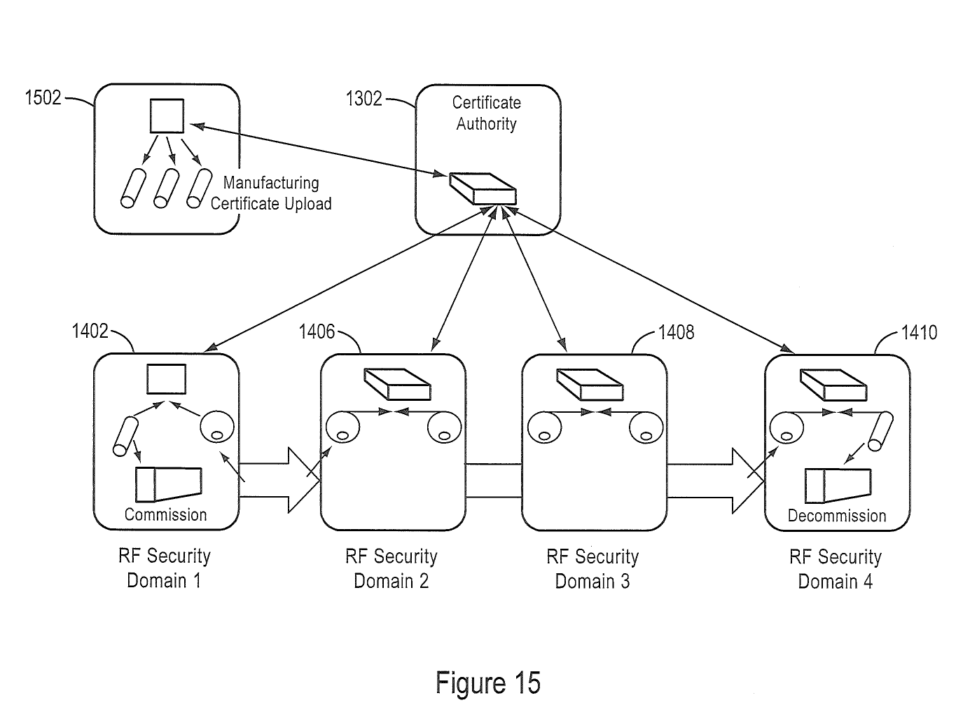

FIG. 15 illustrates tag mobility across secure RFID domains utilizing certificates. As shown in FIG. 15, server 1302 collects certificates from a certificate upload 1502. Each of domains 1402, 1404, 1406, and 1408 then utilizes certificate based security protocols.

In some embodiments, the certificate format can include the Serial Number, the Expiration Date and Certificate Version, the Wireless device public key, and the certificate signature. In some embodiments, the length of the certificate is 72 bytes (6 byte signature, 2 byte Expiration date, 32 byte public key, and 32 byte certificate signature. The Expiration date and Certificate Version may include the year (5 bits), the month (4 bits), the day (5 bits), and version (2 bits). The certificate size may be limited by a requirement that comes from the limitation of wireless frame length. In the 802.15.4 standard, for example, the limit is 127 bytes. Since an X.509 certificate can be about 1K Bytes in length, an X.509 certificate may not be suitable for some deployments.

In some embodiments, a Certificate Authority in server 1302 is capable of generating key pairs (public/private) for wireless devices. The Certificate Authority (CA) can produce a Certificate for each wireless device following above defined format starting from a generated public key. The CA in server 1302 has to sign each wireless device certificate using its private key. The CA can be implemented as an application on a Linux or Windows server, for example using the openSSL library.

During the manufacturing process each wireless device, a reader 120 and tags 110, can be assigned and uploaded a key pair that includes a private key and a public key of the device into the device memory. Also, a copy of a device certificate and CA root certificate can be uploaded into the device memory. For already manufactured devices, as shown in block 1502, this process can be performed as a part of the commissioning process. For each generated key pair, the CA in server 1302 can keep a record in the Certificate Table. That record can, for example, have the following format: Certificate Serial Number, Status (Active|Expired|Revoked), Device ID (Tag ID|Reader ID), Other information.

Once a tag 110 has its own key pair and CA certificates, it can successfully perform mutual authentication with the infrastructure node at the included security domains. A reader 120 can be considered infrastructure, although the security can be terminated from a server inside the network which controls reader 120. If the mutual authentication is successful, the tag 110 can go through session key derivation procedure as described above.

When a tag 110 roams between RFID domains (e.g., from domain 1406 to domain 1408) it may repeat the same mutual authentication and session key derivation procedure with the new RFID domain (domain 1408). If these operations are considered expensive than it is possible to have the session key kept as part of the extended Certificate table, for example Certificate Serial Number, Status (Active|Expired|Revoked), Device ID (Tag ID|Reader ID), session Key, other information. In this case, the tag was mutually authenticated with the infrastructure in the first RFID domain (domain 1406) and there is no need for repeating this procedure with infrastructure which already considers this tag as friendly (i.e. infrastructure in domain 1408). The infrastructure in a particular domain can initiate the mutual authentication procedure on demand or automatically if needed. Since the infrastructure has access to the Certificate Table in server 1302, if the tag 110's certificate gets revoked the infrastructure can stop messaging traffic with this tag 110.

In some embodiments of the present invention as discussed above, secured communications (also referred to as a secure tunnel) can be established between a tag 110 and a reader 120. However, in some embodiments secured communications can be established between a tag 110 and a server 1314 that controls reader 120. In the first option, the RFID reader 120 has either pre-shared key or a certificate in order to perform mutual authentication and session key derivation procedure with a tag 110. During regular data traffic, reader 120 encrypts and decrypts frames. In the case of tag 110 establishing a secured link directly with reader 120, message traffic is protected between tag 110 and reader 120. Further, reader 120 can send ACK or any response in real time, after the frame is decrypted. However, reader 120 needs software and the hardware necessary for encrypting and decrypting data. Additionally, message traffic is often not secured between reader 120 and a server, unless some protocol has been put in place. Further, each reader 120 coupled to a particular server store keys and certificates from tags 110 and has to perform mutual authentication with tags 110, has to communicate with Key Distribution Server 1302 to obtain keying info etc. This added functionality for reader 120 may make reader 120 more complicated from the software (and hardware) perspective.

In the second option a server 1314 controlling one or multiple RFID readers 120 has either pre-shared key or a certificate in order to perform mutual authentication and session key derivation procedure with a tag 110. Server 1314 encrypts and decrypts the traffic. The reader 120 receives encrypted traffic from tag 110 and forwards the encrypted payload to server 1314 over an Ethernet or some other type of link. In some embodiments, reader 120 receives encrypted packet from server 1314 and prepares a frame with received encrypted payload. Reader 120 acts as a wired/wireless bridge or an RFID repeater. In this case, message traffic is protected from tag 110 to server 1314. Key management is simpler and reader 120 does not need to store any of the keys. Reader 120 also does not perform mutual authentication with tags 110, instead server 1314 performs the mutual authentication through a reader 120. Security tunnels from tags 110 are terminated at a single point at a domain, the server 1314. Server 1314 keeps and maintains the Key table, performs encryption/decryption, and other functions. Reader 120 can be a much simpler device. Further, server 1302 need only communicate with a central server 1314 at each site. However, If reader 120 needs to send a response or ACK which depends on the result of decryption, reader 120 will have to wait for server 1314 to generate it. As a result, real time performance may not be available.

As described above, in some embodiments of the invention the system as shown in FIG. 13, for example, is mutually authenticated. The Site Manager, e.g. server 1314 in terminal 1308, is mutually authenticated with server 1302 using certificates. Server 1302 can be SaviTrack, ITV or CMS server. Fixed readers 120 can be mutually authenticated with the server 1314 using certificates, 802.1x or pre-shared secret based security between reader 120 and server 1314. Handheld readers 120 can be mutually authenticated with the server 1314 using certificates, 802.1x or pre-shared secret based, or in some cases directly with server 1302. Tags 110 are mutually authenticated with readers 120, or through readers 120 with servers 1314, using pre-shared secret (a master key), certificate, or PKI authentication.

In some embodiments, the security procedures disclosed herein can be implemented in such a fashion as to be backward compatible with prior standard protocols. For example, tags utilizing an ISO 18000-7 standard may maintain backward compatibility while adding security capabilities described herein.

Embodiments of the invention provided in this disclosure are exemplary only and are not intended to be limiting. One skilled in the art will recognize variations of the invention, each of which should be considered to be within the scope of this disclosure. As such, the invention is limited only by the claims.

We claim:

1. A method of communication between RFID devices, comprising:
mutually authenticating the RFID devices; and
exchanging one or more encrypted payloads based on the encryption scheme.

2. The method of claim 1, wherein mutually authenticating the RFID devices includes a reader device transmitting an “I am a friendly reader” message.

3. The method of claim 1, wherein mutually authenticating the RFID devices includes
transmitting a first challenge to a reader;
receiving an encrypted first challenge and a second challenge;
authenticating the reader based on the encrypted first challenge; and
transmitting an encrypted second challenge to the reader.

4. The method of claim 1, wherein mutually authenticating the RFID devices includes
receiving a first challenge from a reader;
encrypting the first challenge with a pairwise masterkey and transmitting the encrypted first challenge with a second challenge to the reader;
receiving an encrypted second challenge from the reader; and
authenticating the reader based on the encrypted second challenge.

5. The method of claim 1, further including receiving an encrypted broadcast key along with the encrypted first challenge before exchanging one or more encrypted payloads.

6. The method of claim 2, further included providing an acknowledgment after receiving the encrypted broadcast key.

7. The method of claim 1, wherein mutually authenticating the RFID devices includes exchanging certificates between a reader and a tag.

8. The method of claim 1, wherein mutually authenticating the RFID devices includes
receiving a first challenge from a reader in a tag;
transmitting an encrypted first challenge to the reader with a second challenge, the encrypted first challenge being the first challenge encrypted with a tag's private key;
receiving an encrypted second challenge from the reader, the encrypted second challenge being encrypted with the reader's private key.
authenticating the reader and the tag.

9. The method of claim 8, wherein authenticating the reader and the tag includes
comparing the encrypted first challenge with the first challenge; and
comparing the encrypted second challenge with the second challenge.

10. A method of communicating between RFID devices, comprising:
transmitting a collection command;
receiving responses from one or more tag devices;
for each tag device, mutually authenticating with each tag device and communicating encrypted messages with each tag device.

11. The method of claim 10, wherein mutually authenticating is a three-way handshake.

12. The method of claim 10, wherein a broadcast key is sent to the tag after the tag is authenticated.

13. The method of claim 10, wherein the tag transmits an acknowledgment after receiving the broadcast key.

14. The method of claim 10, wherein mutually authenticating relies on exchange of challenges.

15. The method of claim 10, wherein mutually authenticating relies on public key encryption.

16. A security environment, including
a central server;
one or more security domains in communication with the central server, wherein the one or more security domains includes one or more readers that mutually authenticate tags and exchange encrypted messages with tags.

17. The security environment of claim 16, wherein the one or more security domains includes a distribution center and a decommission center.

18. The security environment of claim 16, wherein the one or more security domains includes at least one shipping terminal.

19. The security environment of claim 16, wherein a mutually authenticated tag of a first security domain traveling to a second security domain becomes a mutually authenticated tag of the second security domain through a mutual authentication.

20. The security environment of claim 19, wherein the second security domain receives keys for mutually authenticating the tag from the central server.

21. The security environment of claim 19, wherein travel of the tag between the first security domain and the second security domain is an expected routing of the tag.

22. The security environment of claim 19, wherein travel of the tag between the first security domain and the second security domain is an unexpected routing of the tag.

23. A method of providing tag security, comprising:
providing a tag security to a distribution center;
writing the tag security into a tag at the distribution center;
authenticating the tag at one or more shipping terminals on a shipping route; and
decommissioning the tag at a decommissioning center.

24. The method of claim 23, wherein the tag security includes a pre-shared key.

25. The method of claim 24, wherein authenticating the tag includes exchanges of challenges and encrypted challenges based on the pre-shared key.

26. The method of claim 23, wherein the tag security includes establishment of a public key and a private key.

27. The method of claim 26, wherein mutual authentication includes exchanging challenges encrypted with the public key and the private key.

28. The method of claim 23, wherein the tag security includes establishment of a certificate received from a certificate authority.

29. The method of claim 28, wherein mutual authentication includes exchanging certificates.

30. The method of claim 23, wherein the tag is routed between a first terminal and a second terminal of the one or more shipping terminals.31. The method of claim 30, wherein the tag is mutually authenticated with a shipping terminal upon arrival at the shipping terminal.
